(19) United States
(12) Patent Application Publication
(10) Pub. No.: US 2023/0310262 A1
(43) Pub. Date: Oct. 5, 2023

(54) FLEXIBLE DOUBLE-ENDED VIBRATING DEVICE

(71) Applicant: Plait LLC, Portland, OR (US)

(72) Inventors: Dayna Crozier, Portland, OR (US); Lola Vars, Los Angeles, CA (US)

(73) Assignee: Plait LLC, Portland, OR (US)

(21) Appl. No.: 18/041,862

(22) PCT Filed: Aug. 18, 2021
(86) PCT No.: PCT/US2021/046429

§ 371 Date: Feb. 16, 2023

Related U.S. Application Data
(60) Provisional application No. 63/067,568, filed on Aug. 19, 2020.

(51) Int. Cl. A61H 19/00; A61H 23/02

(52) U.S. Cl. CPC A61H 19/50; A61H 19/44; A61H 23/02; A61H 2201/169; A61H 2201/5002; A61H 2201/5025

(57) ABSTRACT

A flexible, double-ended vibrating device can include two flexible arms, each arm extending outward from an opposite side of the central portion of the device and having a same shape. At least one arm of the two arms can be configured to individually bend into a plurality of bent positions and retain a selected bent position until bent into another selected bent position. The device can further include at least one vibrating motor arranged within the central portion.

### CROSS-REFERENCE TO RELATED APPLICATION

This application claims the benefit of U.S. Provisional Application No. 63/067,568 filed Aug. 19, 2020, herein incorporated by reference.

### FIELD

The present disclosure pertains to flexible, double-ended, vibrating adult sex toys configured to be used by two individuals with vaginas.

### BACKGROUND

There are a variety of sex toys in the adult novelty industry that are geared toward couples in general, but many of the toys created specifically for lesbian and queer couples, such as those with vaginas, are phallic in nature, have purposes that are similar to each other, and do not take into account that couples may desire a different type of experience and stimulation that is not provided with such products. For example, many toys for lesbian and queer couples are configured as strap-on dildos. Additionally, such sex toys often do not seek to supplement different ways these couples might organically have sex regardless of whether toys are present. In one example, many such queer couples engage in the act of scissoring, in which the two individuals interlock lower limbs such that their pelvises interface with one another in an effort to achieve vulva-to-vulva contact. However, such contact may be blocked when additional stimulation (e.g., manual, vibrators, dildos, or the like) is introduced, and so a desired stimulation level simultaneous with vulva-to-vulva contact in act of scissoring, may be difficult to obtain. Thus, a need exists for a vibrating, double-ended sex toy configured to provide supplemental stimulation to make scissoring more satisfying and comfortable.

### SUMMARY

Described herein are embodiments of flexible, doubled-ended vibrating devices. In some embodiments, such flexible double ended vibrating devices can comprise two flexible arms, each arm of the two flexible arms extending outward from an opposite side of a central portion of the device. At least one arm of the two flexible arms can be configured to individually bend into a plurality of bent positions and retain a selected bent position until bent into another selected bent position. The device can further comprise at least one vibrating motor arranged within the device.

In one representative embodiment, a device comprising two flexible arms, each arm of the two flexible arms extending outward from an opposite side of a central portion of the device and having a same shape, at least one arm of the two flexible arms configured to individually bend into a plurality of bent positions and retain a selected bent position until bent into another selected bent position; and at least one vibrating motor arranged within the central portion.

In some embodiments, both arms of the two arms are configured to individually bend into the plurality of bent positions and retain a selected bent position until bent into another selected bent position.

In some embodiments, the central portion has a width that is larger than a width of a portion of at least one arm of the two arms arranged adjacent to the central portion.

In some embodiments, the device further comprises a body comprising a flexible polymeric material and one or more interior wires extending through the two arms.

In some embodiments, each arm includes a bulbous end arranged away from the central portion, the bulbous end having a width that is larger than a width of a portion of the arm arranged between the bulbous end and the central portion.

In some embodiments, the device includes two individually controllable vibrating motors, where a first arm of the two arms includes a bulbous region disposed in the central portion, around a first motor of the two motors, the bulbous region of the first arm having a width that is larger than a width of a portion of the first arm arranged adjacent to the central portion, and where a second arm of the two arms includes a bulbous region disposed in the central portion, around a second motor of the two motors, the bulbous region of the second arm having a width that is larger than a width of a portion of the second arm arranged adjacent to the central portion.

In some embodiments, the central portion includes one or more raised elements arranged between the bulbous region of each of the first arm and the second arm and that extend radially outward relative to each bulbous region of each of the first arm and the second arm, and relative to a central longitudinal axis of the device, where the one or more raised elements are configured to vibrate.

In some embodiments, at least one arm of the two arms includes an identifying marker.

In another representative embodiment, a device comprises two flexible arms extending outward from opposite sides of a central portion of the device, at least one arm of the two flexible arms configured to individually bend into a plurality of bent positions and retain a selected bent position until bent into another selected bent position. The device further comprises two individually vibrating motors configured to be individually controlled, each motor of the two individually vibrating motors arranged within a region of a corresponding arm of the two arms that is disposed in the central portion.

In some embodiments, both arms of the two arms are configured to individually bend into the plurality of bent positions and retain a selected bent position until bent into another selected bent position.

In some embodiments, the device further comprises a body comprising a flexible polymeric material and one or more interior wires extending through the two arms.

In some embodiments, the one or more interior wires comprises a single continuous wire with free ends that are arranged into a loop at a free end of each arm of the two flexible arms.

In some embodiments, a first arm of the two arms includes a first power button configured to control a first motor of the two motors, and a second arm of the two arms includes a second power button configured to control a second motor of the two motors.

In some embodiments, the central portion includes one or more raised elements arranged between the region of each arm that the motors are arranged within, and that extend radially outward relative to each region of each arm, and relative to a central longitudinal axis of the device, where one or more of the one or more raised elements are configured to vibrate.

In another representative embodiment, a device comprises two flexible arms extending outward from opposite sides of a central portion of the device, both arms of the two arms configured to individually bend into a plurality of bent positions and retain a selected bent position until bent into another selected bent position. The device further comprises two individually vibrating motors configured to be individually controlled, each motor of the two individually vibrating motors arranged within a corresponding arm of the two arms.

In some embodiments, the device further comprises a body comprising a flexible polymeric material and one or more interior wires extending continuously through the two arms and around the two individually vibrating motors. In some embodiments, the one or more interior wires comprises a single, continuous wire that extends from a first end of the device to a second end of the device and that coils around each of the two individually vibrating motors one or more times and extends between the two individually vibrating motors.

In some embodiments, a first arm of the two flexible arms has a first size and a second arm of the two flexible arms has a second size, the second size larger than the first size.

In some embodiments, the central portion comprises one or more raised elements that extend radially outward relative to a central longitudinal axis of the device and around a circumference of the device, and the one or more raised elements are disposed between the two individually vibrating motors in an axial direction.

In some embodiments, the two individually vibrating motors comprise a first motor and a second motor, each of the first motor and the second motor disposed within a region of a corresponding arm of the two arms that is disposed in the central portion and further comprising a third vibrating motor disposed in a distal, free end of a first arm of the two arms and a fourth vibrating motor disposed in a distal, free end of a second arm of the two arms.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a first side view of a first embodiment of a flexible, double-ended vibrating device.

FIG. 2 is a second side view of the device of FIG. 1, rotated from the first side view by approximately 90 degrees.

FIG. 3 is a cross-sectional view of the device of FIG. 2, showing internal components of the device.

FIG. 4 is a side view of the device of FIG. 1, illustrating a bendability of ends of the device.

FIG. 5 is a first side view of another embodiment of a flexible, double-ended vibrating device.

FIG. 6 is a second side view of the device of FIG. 5, rotated from the first side view by approximately 90 degrees.

FIG. 7 is a cross-sectional view of the device of FIG. 6, showing internal components of the device.

FIG. 8 is a side view of another embodiment of a flexible, double-ended vibrating device where identifying markers are located at respective ends of the device.

FIG. 9 is a side view of another embodiment of the device of FIG. 1 where raised center elements of the device are configured as two central rings.

FIG. 10 is a side view of another embodiment of the device of FIG. 5 where raised center elements of the device are configured as two central rings.

FIG. 11 is a side view of another embodiment of the device of FIG. 1 where raised center elements of the device are configured as a single central ring.

FIG. 12 is a side view of another embodiment of the device of FIG. 5 where raised center elements of the device are configured as a single central ring.

FIG. 13 is a side view of another embodiment of the device of FIG. 1 where the raised center elements are configured as a single, shared central bump.

FIG. 14 is a side view of another embodiment of the device of FIG. 5 where raised center elements of the device are configured as a single, shared central bump.

FIG. 15 is a side view of another embodiment of the device of FIG. 1, but a central portion of the device does not include any center raised elements separating first and second arms of the device.

FIG. 16 is a side view of another embodiment of the device of FIG. 5, but a central portion of the device does not include any center raised elements separating first and second arms of the device.

FIG. 17 is a side view of another embodiment of a flexible, double-ended vibrating device, similar to the device of FIG. 1, but a central portion of the device has a single bulbous region housing a single motor that is shared between first and second arms of the device.

FIG. 18 is a side view of another embodiment of a flexible, double-ended vibrating device, similar to the device of FIG. 5, but a central portion of the device has a single bulbous region configured to house a single motor that is shared between first and second arms of the device.

FIG. 19 is a side view of another embodiment of a flexible, double-ended vibrating device where a central portion of the device has a single bulbous region and first and second arms include additional bulbs.

FIG. 20 is a side view of another embodiment of a flexible, double-ended vibrating device where a central portion of the device has a single bulbous region and first and second arms include additional and varying numbers of bulbs.

FIG. 21 shows an exemplary remote control device that is configured to remotely control and adjust operation of a flexible, double-ended vibrating device having two individually controllable vibrating motors.

FIG. 22A shows an exemplary embodiment of an inductive charging system for and connected to a flexible, double-ended vibrating device.

FIG. 22B shows a schematic of a side view of the inductive charger of FIG. 22A.

FIG. 23A shows another exemplary embodiment of an inductive charging system for and connected to a flexible, double-ended vibrating device.

FIG. 23B shows a schematic of a view of an empty inductive charger cradle of the inductive charging system of FIG. 23A.

FIG. 24A shows another exemplary embodiment of an inductive charging system for and connected to a flexible, double-ended vibrating device.

FIG. 24B shows an exemplary top view of the inductive charging system of FIG. 24B.

FIG. 25 is a perspective view of another embodiment of a flexible, double-ended vibrating device.

FIG. 26 is a perspective cross-sectional view of the device of FIG. 25 with two central motors arranged within a central portion of the device.

FIG. 27 is a perspective cross-sectional view of the device of FIG. 25 with two central motors arranged within a central portion of the device and an additional two motors arranged within ends of the device.

FIG. 28 is a perspective cross-sectional view of the device of FIG. 25 with two motors arranged within ends of the device

FIG. 29 is a perspective transparent view of the device of FIG. 25 with two central motors arranged within a central portion of the device and a flexible element that coils around the two central motors.

FIG. 30 is a side transparent view of the device of FIG. 25 with two central motors arranged within a central portion of the device, an additional two motors arranged within ends of the device, and a flexible element that coils around the two central motors and loops around the additional two motors.

FIG. 31 is a detail view of one of the central motors of the device of FIG. 30 showing the coiling of the flexible element around one of the central motors.

FIG. 32 is a perspective view of another embodiment of a flexible, double-ended vibrating device comprising a removable central motor.

FIG. 33 is a cross-sectional view of the device of FIG. 32.

FIG. 34 is a perspective transparent view of the device of FIG. 25 with one central motor arranged within a central portion of the device and two motors arranged within ends of the device.

### DETAILED DESCRIPTION

As introduced above, it may be desirable for a sex toy for queer couples, such as those having vaginas, to enable and enhance vulva-to-vulva (or groin-to-groin area) stimulation between partners, when in a scissoring position.

In some embodiments, the sex toy devices described herein are double-ended so that they can be used, together (e.g., at the same time), such as by two individuals with vaginas. The double-ended sex toy devices described herein can be further configured to bend and vibrate, thereby enhancing the act of scissoring between two individuals.

In some embodiments, the flexible, double-ended devices described herein can be used by two individuals, either or both with or without vaginas, wherein the arms of the device are configured to be received within orifices of the two individuals (which, in some embodiments, may include a vagina). For example, in some embodiments, the devices can be used herein by two individuals, where one or both of the individuals does not have a vagina. As another example, in some embodiments, the devices described herein can be configured to be received within the anuses of one or more individuals.

In some embodiments, the devices described herein can be used by one individual (e.g., a single individual). For example, a first arm of the device can be configured to be inserted into the individual's desired orifice while a second arm of the device can be used as a handle, thereby providing potential dual stimulation of the individual user's clitoris and G spot and/or vagina, as well as a bendable handle for greater user accessibility. In other embodiments, a first arm of the device can be configured to be inserted into the individual's vagina while a second arm of the device can be inserted into the individual's anus, thereby providing multiple locations of stimulation.

In some embodiments, the devices described herein can include at least one flexible arm.

In some embodiments, the devices described herein can include two flexible arms, each of the two flexible arms extending outward from an opposite side of a central portion of the device. One or both of the arms can be configured to individually bend into a plurality of bent positions and retain a selected bent position until bent into another selected bent position.

In some embodiments, the central portion has a width that is larger than a width of a portion of each arm arranged adjacent to the central portion, and thus, the central portion can be configured to provide clitoral stimulation to both partners without blocking vulva-to-vulva contact between partners. The device can further include at least one vibrating motor. In some embodiments, the at least one vibrating motor can be arranged within the central portion. In some embodiments, the width of the central portion that is larger than the width of the portion of one or more of the arms arranged adjacent to the central portion can be only slightly larger (e.g., 5-30% larger, 10-25% larger, or 15-20% larger). In other embodiments, the width of the central portion that is larger than the width of the portion of one or more of the arms arranged adjacent to the central portion can be at least 50% larger than the portion of one or more of the arms arranged adjacent to the central portion.

In some embodiments, the double-ended sex toy devices described herein can be adapted according to a user's desired level of penetration. For example, the ends of the double-ended devices described herein can have various sizes and the two ends of a same device can have differently sized ends to accommodate the partners' different preferences.

In some embodiments, one or more of the double-ended sex toy devices described herein can include a single, central vibrator (e.g., vibrating motor) for shared clitoral stimulation between the partners.

In some embodiments, one or more of the double-ended sex toy devices described herein can include two central vibrators (e.g., vibrating motors), one for each partner of the couple. In some embodiments, each partner can choose their own intensity of vibration of their vibrator.

In some embodiments, one or more of the double-ended sex toys described herein can include (in addition to or in place of one or more central vibrators), two vibrators, including one vibrator disposed in a distal end of each arm of the device.

In some embodiments, one or more of the double-ended sex toys described herein can include one or more central vibrators and a vibrator in a distal (e.g., free) end of each arm of the device.

In some embodiments, the double-ended sex toy device can include one or more central features, arranged between the two ends, that is sized to provide clitoral stimulation to both partners while also allowing both partners' vulvas to touch one another (e.g., without blocking contact between the partners). In some embodiments, the central features are configured as raised central elements (e.g., rings or annular bumps).

In some embodiments, each end of the double-ended sex toy device is configured to bend individually and stay in position until it is bent it into a different position. This may make the toy hands free once it's in place, and both the bendability and the bulbous ends can keep the toy from easily slipping out the individuals' vaginas.

In some embodiments, the double-ended sex toy device described herein can be configured to be small enough to only provide shallow vaginal penetration to mimic fingers, rather than penises. In this way, one or both arms of the doubled-ended device can be sized to be non-phallic. This can make the vulva-to-vulva contact in scissoring both more achievable and comfortable, and to also provide added, hands-free stimulation so partners don't have to contort into awkward positions to provide manual stimulation/penetration.

In some embodiments, one or more of the double-ended sex toy devices described herein can have differently sized ends, including one side that is smaller for the partner who wants more shallow penetration, and one side that is larger for the partner who wants deeper penetration. This provides one device that works for two individuals with vaginas that prefer different levels of penetration. In some embodiments, both end of the double-ended sex toy can have ends that are large enough to provide deeper penetration.

In this way, in some embodiments, the devices described here can be configured to improve and/or supplement scissoring for queer and lesbian sex between two partners with vaginas. These devices described further below can create a more equal dynamic between partners of a couple and a shared sexual experience for both queer/lesbian partners at the same time.

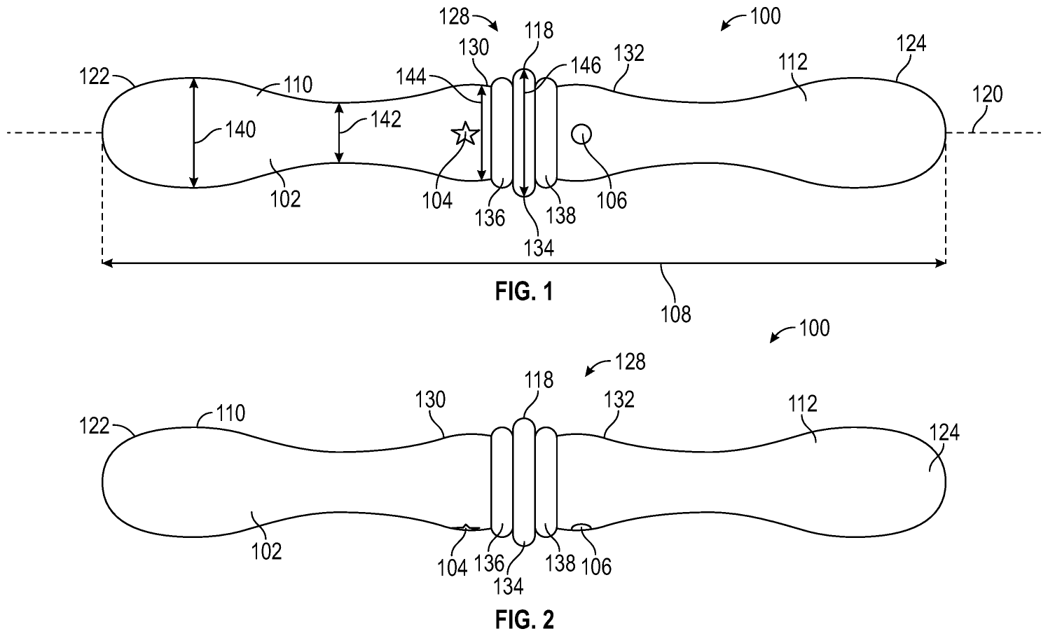

FIGS. 1-20 and 25-33 illustrate various embodiments of a flexible, double-ended vibrating device (e.g., sex toy) configured to provide simultaneous stimulation to two individuals (e.g., partners or users) who each have a vagina while scissoring. As used herein, “scissoring” is defined as a position where two individuals with vaginas intertwine legs (e.g., like scissors) such that their pelvises are arranged adjacent (e.g., facing) and/or adjoining one another and their vulvas are arranged toward one another and may contact one another.

In some embodiments, the devices disclosed below with reference to FIGS. 1-20 and 25-33 can have an exterior and interior device body, excluding interior mechanical and electrical components, that is comprised of a medical grade polymeric material, such as silicone. The interior parts of the devices can be housed within and surrounded by this solid polymeric (e.g., silicone) body. For example, in some embodiments, the internal components of the device can be encased by and held within the solid polymeric body of the device.

In some embodiments, one or more flexible or bendable components, such as one or more bendable wires, may be arranged within the silicone (or other, similar polymer) body and extend along at least a portion of a length of each end of the device. The solid silicone body can add resistance to bending of the ends of the device and protect the interior bendable element or elements (e.g., wire or wires) from shifting within the device.

In some embodiments, the silicone or other polymeric material of the body of the device can thinly cover the exterior of power buttons and/or inductive charging port(s) of the device to ensure the device is submersible in a fluid (e.g., a cleaning fluid and/or bodily fluid).

In some embodiments, the device exterior can be seamless and free of cracks or openings to keep it clean and watertight and to minimize uncomfortable friction.

In some embodiments, the device can be completely round along the length of the toy, including arms, motors, raised center rings or bulbs, and arm bulbs. Thus, in some embodiments, the device is not flattened anywhere (e.g., little to no planar portions or square corners), and the shape can look the same when rotated around a central longitudinal axis of the device (e.g., the device may be symmetrical around the central longitudinal axis).

In some embodiments, as described further below, the bulbous ends and bendable arms of the device can help to keep the toy inserted in place and moving with partners' bodies for more control. In some embodiments, the bulbous ends of the device can also be configured to stimulate the G spot of the user.

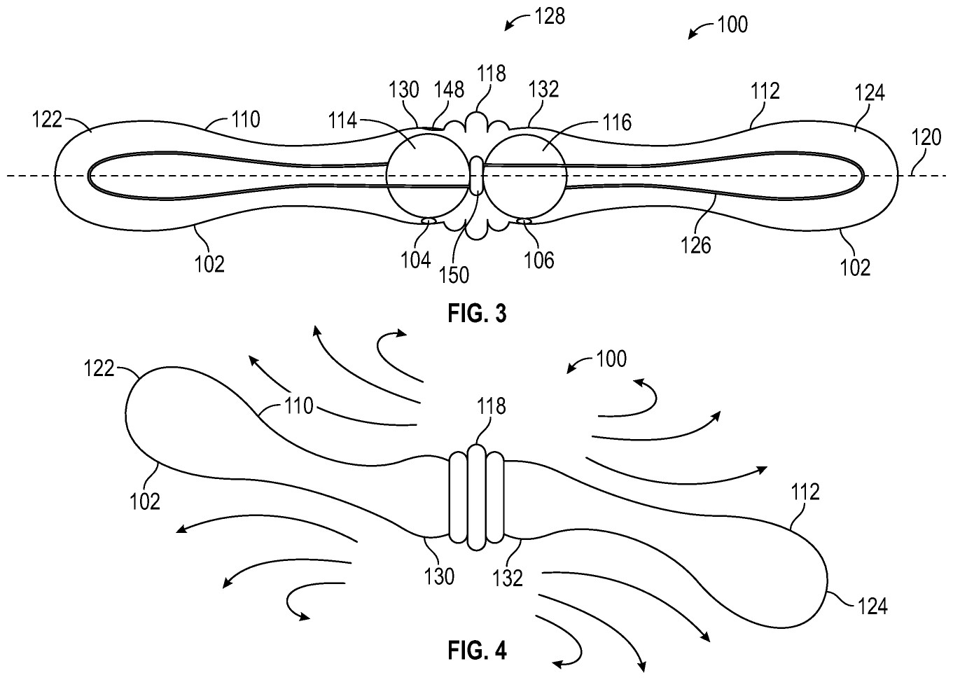

Turning to FIGS. 1-4, a first embodiment of a flexible, double-ended vibrating device 100 (e.g., sex toy) is shown. FIG. 1 is a first side view of the device 100 which shows an exterior of the device. FIG. 2 is a second side view of the device 100, rotated by approximately 90 degrees from the first side view of FIG. 1. FIG. 3 shows a cross-sectional view of the device 100, from the second side view and FIG. 4 illustrates a bendability of ends of the device 100.

The device 100 can include two arms 110 and 112 (e.g., elongate arms) extending outward from a central portion (e.g., region) 128 of the device 100. The first arm 110 can include a free end 122 (also referred to herein as a bulbous end, in some embodiments) that is spaced away from the central portion 128. The second arm 112 can include a free end 124 that is spaced away from the central portion 128. As used herein, a first component being “spaced away from” a second component refers to the first component (e.g., end 122 or end 124) not being directly coupled to the second component and at least one intervening portion of a component being arranged between the first and second components.

The arms 110 and 112 are flexible and can be configured to bend individually, as explained further below. For example, in some embodiments, at least one of the arms 110 and 112 can be configured to individually bend into a plurality of bent positions and retain a selected bent position until bent into another selected bent position. In some embodiments, each of the arms 110 and 112 can be configured to individually bend into a plurality of bent positions and retain a selected bent position until bent into another selected bent position.

Further, in some embodiments, the central portion can have a width that is larger than a width of a portion of at least one of or both arms arranged adjacent to the central portion. As used herein, “width” can refer to a dimension that is arranged perpendicular to a central longitudinal axis 120 of the device 100 and/or may be referred to as a diameter of the device 100.

As introduced above, a body 102 of the device 100, aside from interior mechanical and electrical components, can comprise a medical grade polymeric material. In some embodiments, the body 102 can comprise a medical grade silicone. The interior parts (as shown in FIG. 3 and described further below) can be housed within and/or embedded within and surrounded by this solid polymeric (e.g., silicone) body 102.

The body 102 can be configured (e.g., via its material, thickness, and the like) to add resistance to the bendability of the device 100, thereby protecting an interior bendable element (e.g., wire) from shifting within the device 100.

In some embodiments, the polymeric material forming the body 102 can also thinly cover an exterior of the power buttons 104 and 106 and, in some embodiments, an inductive charging port 148 (FIG. 3) to ensure the device 100 is submersible.

In some embodiments, the body 102 can have a continuous outer surface that is seamless and free of cracks or openings to keep it clean and watertight and to minimize uncomfortable friction. The device 100 can be curved and rounded (e.g., no square or sharp edges) along a length 108 of the device 100 (FIG. 1), including the arms 110 and 112, portions of the central portion 128 containing the motors 114 and 116 (FIG. 3), and raised center elements (e.g., rings) 118. For example, in some embodiments, the device 100 is not flattened anywhere (e.g., little to no planar portions), and the shape can be symmetric and look the same when rotated along a central longitudinal axis 120 of the device 100.

For example, in some embodiments, at least one of the first arm 110 and the second arm 112 can be symmetric around a central longitudinal axis of the arm, the central longitudinal axis extending from a free end of the arm (e.g., first bulbous end 122 or second bulbous end 123) to the central portion 128. In some embodiments, the central longitudinal axis of the first arm 110 and the second arm can be the central longitudinal axis 120 shown in FIG. 1 which runs through a center of the device 100, from the first bulbous end 122, through the central portion 128, to the second bulbous end 124.

The first and second bulbous ends 122 and 124 of the bendable first and second arms 110 and 112, respectively, and the first and second arms 110 and 112 can be configured to keep the device 100 inserted in place and moving with partners' bodies for more control.

In some embodiments, the first and second bulbous ends 122 and 124 can also stimulate each partner's G spot. For example, a length of each of the first and second arms 110 and 112 can be sized such that they can reach and stimulate each user's G spot. However, in alternate embodiments of the device where one or more of the first and second arms 110 and 112 are longer, G spot stimulation may not occur.

The first arm 110 can be inserted into the vagina of a first partner for vaginal penetration and G spot stimulation of the first partner. The second arm 112 can be inserted into the vagina of a different, second partner for vaginal penetration and G spot stimulation of the second partner.

Each of the first arm 110 and the second arm 112 can bend smoothly (e.g., due to one or more internal metal wires 126 (FIG. 3), or one or more alternate bendable elements, embedded within the silicone, or other polymeric, body 102) and remains bent in position until bent into a new position (FIG. 4 shows exemplary bending of the arms 110 and 112). For example, after bending each of the arms 110 and 112 into a desired position, they may remain in that position, even during use while inserted into one of the partners' vaginas, and they do not flop back to a default or straight position.

In some embodiments, the device 100 can include a single, continuous internal wire 126 that is routed between the first bulbous end 122 and the second bulbous end 124 and around the motors 115 and 116.

In some embodiments, a thickness of the body 102 surrounding the wire 126 can be selected to add to the resistance from being bent out of the desired position and can also keep the wire 126 safely in place along the center (e.g., central longitudinal axis 120) of the device 100. In some embodiments, a thickness of the wire 126 can be selected to additionally or alternatively achieve a desired bending resistance to allow the arms of the device to hold the desired bent position without being bent out of place (e.g., until being manually moved to another desired position by a user).

In some embodiments, the wire 126 is embedded (or encased) within the polymeric (e.g., silicone) body 102.

In some embodiments, the wire 126 is arranged within a cavity within the polymeric (e.g., silicone) body 102.

In some embodiments, the wire 126 comprises metal. In these embodiments, the wire 126 can radiate some vibration from the central motors 114 and 116 to the ends 122 and 124 of the device 100 for vaginal stimulation. For example, as shown in FIG. 3, while the motors 114 and 116 (or in alternate embodiments, a single central motor) can be arranged in a central portion (e.g., region) 128 of the device 100, vibrations created from each of the motors 114 and 116 can radiate and travel along the wire 126, toward a corresponding one of the ends 122 and 124, thereby allowing enabling stimulation of the vagina in which the corresponding one of the ends 122 and 124 is arranged.

In other embodiments, vibration produced by one or more of the motors 114 and 116 can be localized to a portion of the body 102 housing or surrounding the one or more motors.

As introduced above, in some embodiments, the length of each arm 110 and 112 can be long enough to provide G spot stimulation but may be shorter than a traditional dildo that is phallic in shape and simulates a size (e.g., length) of a penis. In this way, the length of the arms 110 and 112 can be configured for more shallow, G spot stimulation, as compared to more traditional dildos that are more phallic in shape (e.g., longer and/or thicker). Exemplary lengths for the device 100 and the arms 110 and 112 are described further below.

At least one or each of the first and second arms 110 and 112, from the respective bulbous (e.g., free) ends 122 and 124 to the central portion 128 can curve radially inward, toward the central longitudinal axis 120, at a location between the respective end 122 and 124 and the central portion 128, and then curve radially back outward at a region adjacent to the central portion 128, which includes one of the motors 114 and 116.

For example, in some embodiments, the first arm 110 can include a first bulbous region 130 arranged at (or in) the central portion 128 (and in some embodiments, adjacent to the center elements 118, as shown in FIG. 1) which houses the first motor 114. The first motor 114 provides clitoral stimulation for the first partner. The bulbous shape and size of the first bulbous region 130 can be large enough to contribute to clitoral stimulation, but can also be small enough that it does not block both partners' vulvas from touching each other, thereby enabling scissoring.

Similarly, in some embodiments, additionally or alternatively, the second arm 112 can include a second bulbous region 132 arranged at (or in) the central portion 128 (and in some embodiments, adjacent to the center elements 118) which houses the second motor 116. The second motor 116 provides clitoral stimulation for the second partner. The bulbous shape and size of the second bulbous region 132 can be large enough to contribute to clitoral stimulation, but can also be small enough that it does not block both partners' vulvas from touching each other, thereby enabling scissoring.

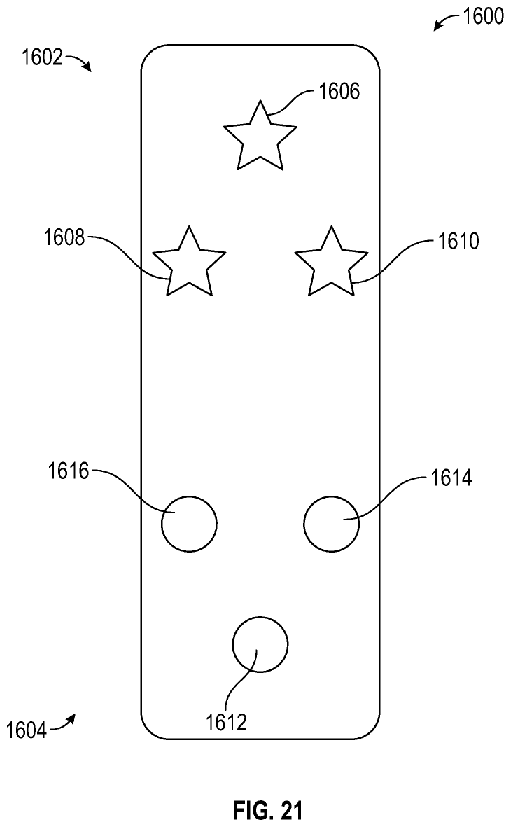

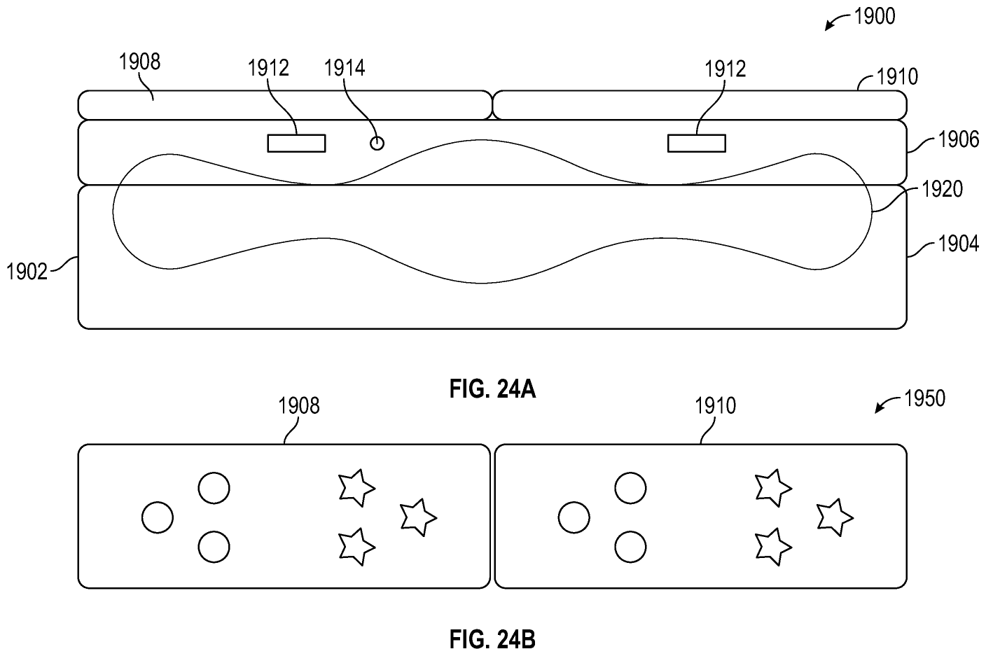

In some embodiments, each of the first and second motors 114 and 116 can be separately controlled via its own power and intensity buttons, on the device 100 and on corresponding remote controls, as described further below with reference to FIGS. 21 and 24. Each partner can change the intensity of their own motor's vibration to their own liking, as well as their partner's motor, via the individual power buttons 104 and 106 and/or the corresponding remote controls.

As shown in FIGS. 1-3, the first and second bulbous regions 130 and 132 housing the respective motors 114 and 116 are spaced away from the respective ends 122 and 124 of the respective arms 110 and 112, thereby making them centrally located.

In alternate embodiments, instead of two, individually controllable motors 114 and 116, the device 100 can include a single motor arranged in the central portion 128 or adjacent to one side of the central portion 128.

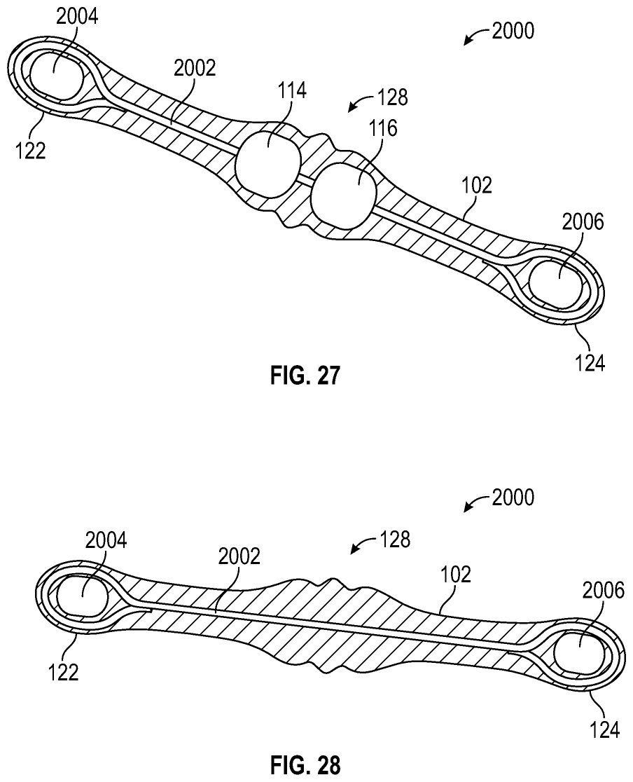

Further, in some embodiments, the device 100 can additionally (e.g., in addition to the central motors 114 and 116) or alternatively (e.g., instead of the central motors 114 and 116) include a motor in one or each of the bulbous ends 122 and 124 (e.g., as shown in FIGS. 27, 28, 30, and 34 as described in further detail below).

As introduced above, each arm 110 and 112 and each motor 114 and 116 of the device 100 can have a different, corresponding power button. For example, as shown in FIG. 1, the device can include the first power button 104 configured to actuate (e.g., turn off and on and/or control an intensity level of) the first motor 114 for the first arm 110 and the second power button 106 configured to actuate the second motor 116 for the second arm 112.

In alternate embodiments where the device includes three or four motors (e.g., as shown in FIGS. 27, 30, and 34), each arm 110 and 112 of the device 100 can have a different corresponding power button. For example, the device can include a first power button (e.g., button 104 described above) configured to actuate (e.g., turn off and on and/or control an intensity level of) the first motor 114 and a third motor 2004 of the first arm 110 and the second power button 106 configured to actuate the second motor 116 and a fourth motor 2006 for the second arm 112 (FIGS. 27 and 30).

In some embodiments, at least one of the first arm 110 and the second arm 112 can include an identifying marker in a form of a shape, pattern, or the like, that may be arranged on the body 102 of the arm (and, in some embodiments, may be raised relative to the outer surface of the body 102).

For example, in some embodiments, at least one of or each of the first and second power buttons 104 and 106 can have a unique identifying (or differentiable) marker (e.g., mark) or shape. For example, as shown in FIG. 1, the first power button 104 for the first partner's side of the device 100 can have a first shape (e.g., a star) and the second power button 106 for the second partner's side of the device 100 can have a different, second shape (e.g., a circle). In alternate embodiments, the shapes of the power buttons 104 and 106 can be a different combination of shapes than those shown in FIG. 1, such as a square, triangle, rectangle, crescent moon, sun, or the like. Further, in some embodiments, instead of being shapes, the power buttons 104 and 106 can be differently shaped symbols or combinations of shapes or symbols, such as a series of lines vs. dots or a number sign vs. an Asterix.

The different shapes of the first and second power buttons 104 and 106 can be differentiable by the users, thereby indicating which arm (or side) of the device 100 corresponds to which partner. In some embodiments, by utilizing different shapes (e.g., rather than just different color buttons) that are raised relative to an outer surface of the body 102, the first and second power buttons 104 and 106 provide a tactile function such that the two partners can feel which side corresponds to their side in the dark (e.g., during use when visibility is low).

In some embodiments, the device 100 can include differentiating marks or markers that are configured as power buttons 104 and 106. In alternate embodiments, the differentiating markers can be separate from the power buttons 104 and 106 and arranged on another portion of the device (e.g., as shown in FIG. 8, as described further below).

In some embodiments, the first and second power buttons 104 and 106 can include an accompanying light which lights up to uniquely identify each side of the device 100 in the dark, and to indicate when the device 100 is charging. In some embodiments, each of the first and second power buttons 104 and 106 can light up in a different color (e.g., red and green).

In alternate embodiments, only one of the first power button 104 and the second power button 106 can have an identifying marker (which may be raised in some embodiments).

Each of the first and second power buttons 104 and 106 can be a single button that turns the corresponding motor 114 and 116 (as well as corresponding motors 2004 and 2006 in alternate embodiments) on and off by holding it down, and, in some embodiments, can also cycle through multiple vibration intensities with each press of the button.

Since each partner can have their own power button for their own motor or motors, there may also be one or more corresponding remote controls, each enabling the individual partner to control their own vibration and/or the other partner's vibration (as described further below). The differentiating shapes can also help each partner know which side they're controlling via the remote (e.g., the same shapes or symbols can be used on the remote, as described further below with reference to FIGS. 21 and 24).

In some embodiments, the central portion 128, between the first and second arms 110 and 112, can include one or more raised center elements (also referred to as raised elements or central raised elements) 118 configured to provide clitoral stimulation for both of the two partners (users). In some embodiments, as shown in FIGS. 1-4, the one or more raised center elements 118 can be configured as rings that extend radially outward relative to adjacent portions of the arms 110 and 112, and relative to the central longitudinal axis 120. For example, in some embodiments, as shown in FIGS. 1-4, the raised elements 118 can include a central first ring 134 and two side rings 136 and 138 (e.g., one on either side of and connected with the first ring 134).

In some embodiments, the raised elements 118 are disposed between the first motor 114 and the second motor 116, in an axial direction that is relative to the central longitudinal axis 120.

These three raised center rings 118 are configured to provide additional, shared clitoral stimulation for both partners. Vibration can be felt in one or more of these rings 118, as well as directly over the motors 114 and 116 (e.g., at first and second bulbous regions 130 and 132).

While each motor vibrates at the intensity of its user's liking (e.g., according to their selection or predetermined settings), the raised center rings 118 can carry and blend the vibration of both sides.

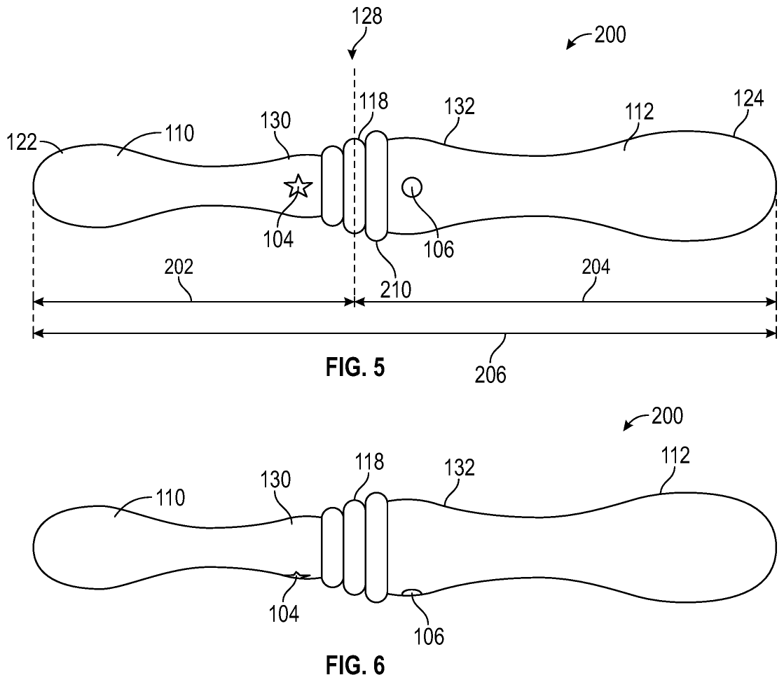

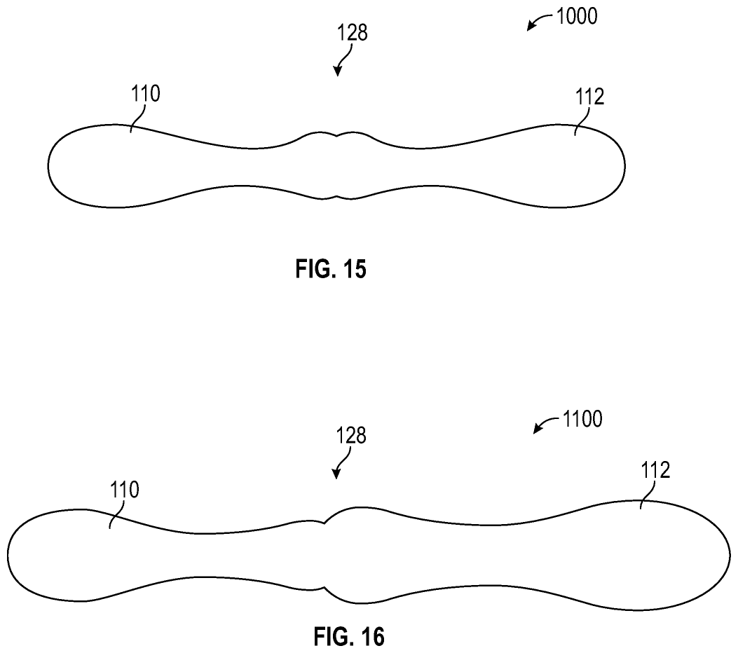

In alternate embodiments, the raised center elements 118 can include more or less than three rings (e.g., one, two, four, or the like) and/or can have different shapes and/or sizes (e.g., different lengths, widths, curvature, etc.). Exemplary embodiments of different configurations of the raised center elements 118 are shown in FIGS. 5-14 and 25-30 and 32-33 and exemplary embodiments of similar devices without the raised center elements are shown in FIGS. 15-20.

As shown in FIG. 1, the device 100 can have an overall length 108, a width (also referred to herein as a diameter) 140 at the bulbous ends 122 and 124, a width (e.g., diameter) 142 at a narrower, center portion, of each of the arms 110 and 112, a width (e.g., diameter) 144 at the first and second bulbous regions 130 and 132 around the motors, and a width (e.g., diameter) 146 at the central first ring 134.

In some embodiments, the length 108 can be in a range of 12.7 to 30.5 cm (e.g., 6.35 to 15.25 cm each side or arm), the width 140 can be in a range of 1.27 to 4.45 cm, the width 142 can be in a range of 0.64 to 3.18 cm, the width 144 can be in a range of 1.27 to 4.45 cm, and the width 146 can be in a range of 1.91 to 4.45 cm.

In some embodiments, such as a smaller sized device, the length 108 can be about 12.7 to 20.32 cm (e.g., 6.35 to 10.16 cm each side or arm), the width 140 can be about 1.27 to 2.54 cm, the width 142 can be about 0.64 to 1.91 cm, the width 144 can be about 1.27 to 2.54 cm, and the width 146 can be about 1.91 to 3.18 cm.

In some embodiments, such as a larger sized device, the length 108 can be about 30.48 cm (e.g., 15.24 cm each side or arm), the width 140 can be about 2.54 to 3.81 cm, the width 142 can be about 1.91 to 3.18 cm, the width 144 can be about 2.54 to 3.81 cm, and the width 146 can be about 3.18 to 1.25 to 4.45 cm.

For example, the larger sized device can be similar in shape and size to the smaller sized device, but larger in scale.

In some embodiments, the device 100 can be configured to charge with inductive charging. For example, in some embodiments, the device 100 can include a charger port 148 just beneath an outer surface of the body 102 (e.g., beneath the silicone), but close enough to the surface to charge the device 100 (FIG. 3). In some embodiments, the charger port 148 can be embedded within the polymeric (e.g., silicone) material of the device 100, below the outer surface of the body 102.

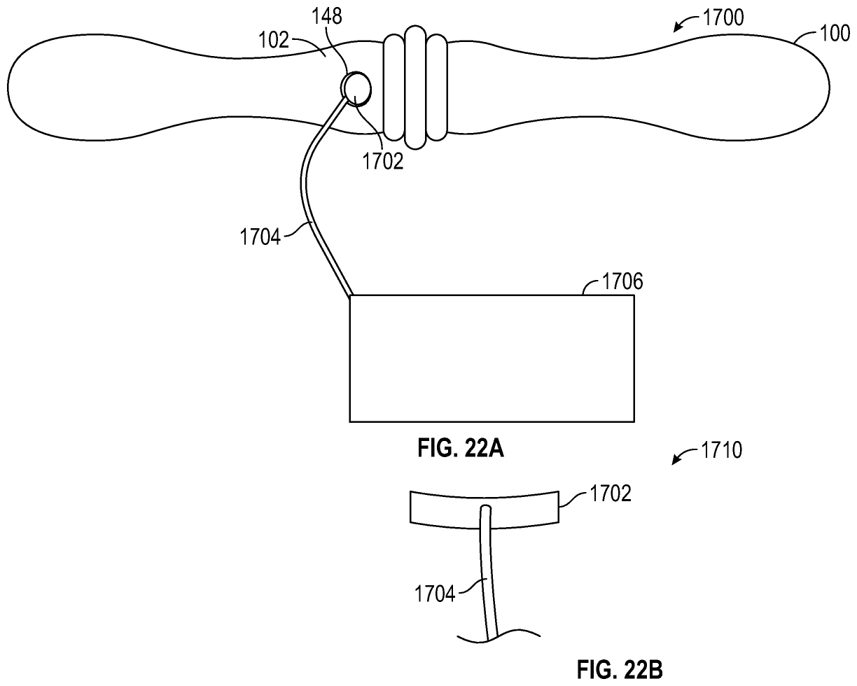

Keeping the device completely covered and the silicone (or alternate polymeric material) relatively seamless (e.g., by not including an external electrical charging port) can increase the cleanliness of the device 100 (e.g., no cracks or openings for fluids to get stuck in) and reduce or prevent irritating friction between the device and anatomy of the user(s). In some embodiments, the device 100 charges via an inductive charger, as explained further below with reference to FIGS. 22-24.

As introduced above, in some embodiments, an entire exterior of the device 100 is comprised of medical grade silicone (or another medical grade polymer). As shown in FIG. 3, the interior parts of the device 100 are housed within and surrounded by this solid silicone body 102. The solid silicone body 102 adds resistance to the bend, and can be configured to protect the interior wire from shifting within the device.

The arms 110 and 112 of the device 100 can be configured to bend, individually, into a desired orientation (e.g., as shown in FIG. 4). For example, the device 100 can include one or more internal wires (e.g., one shown in FIG. 3) 126 arranged within the interior of the device 100, which are configured to bend. In some embodiments, the one or more wires 126 can extend through at least a portion of a length of both arms 110 and 112. In some embodiments, the one or more wires 126 can extend through a majority of a length of at least one of the arms 110 and 112. In some embodiments, the one or more wires 126 can extend through a majority of a length of each of the arms 110 and 112.

In some embodiments, the one or more wires 126 can be a single wire 126. In some embodiments, the wire 126 can be one piece of galvanized metal wire that runs through the interior length of the device 100. In some embodiments, the wire 126 can run, loop, and/or wrap around the motors 114 and 116. The wire provides the device's bendability and ability to keep the bent configuration until bent into a new position or configuration. This allows the device 100 to move with the users' bodies and to keep it from being unwieldy and falling out of their vaginas.

In some embodiments, the wire can be a galvanized metal wire with a thickness in a range of about 16 gauge-12 gauge (e.g., about 1.3 mm-2 mm).

In some embodiments, the first and second motors 114 and 116 can be configured (e.g., sized) as vibrating motors. In some embodiments, the vibrating first and second motors 114 and 116 can be configured to provide relatively high intensity clitoral stimulation, with variable intensity, but the first and second motors 114 and 116 can be sized small enough that they do not block both partners' vulvas from touching each other (FIG. 3).

As shown in FIG. 3, in some embodiments, both ends of the metal wire 126 can be connected at a connection interface 150 with a plastic cap, a sheath, glue, or another element configured to ensure that the wires stay in place within the body 102 and cannot pierce through the body 102.

FIG. 4 shows an exemplary embodiment of the flexibility (e.g., bendability) of the arms 110 and 112 of the device 100. As shown in FIG. 4, the arms 110 and 112 of the device 100 can bend in a plurality of directions and stay in position until bent in another direction. Further, the first arm 110 can be bent at a different angle and/or in a different direction than the second arm 112. In this way, the first and second arms 110 and 112 are individually adjustable by their intended user (e.g., partner), thereby providing a customized stimulation and experience for each user that can be adjusted during a period of use and/or between uses.

The hardness, closeness (e.g., distance between), and mass of the interior motors 114 and 116 can keep the central portion 128 and/or the first and second bulbous regions 130 and 132 fairly stationary while the arms 110 and 112 of the device 100 can bend.

FIGS. 5-7 show another embodiment of a flexible, double-ended vibrating device 200 (e.g., sex toy). The device 200 can be similar to device 100 of FIGS. 1-4, and thus, similar elements to those of device 100 have been labeled similarly in FIGS. 5-7 and will not be redescribed below for the sake of brevity.

Device 200 can be configured to accommodate one partner who wants less vaginal penetration and one partner who wants more vaginal penetration, as not all people with vaginas enjoy the same level of penetration or have anatomy of a same size. The main difference between device 200 and device 100 is that device 200 includes differently sized arms 110 and 112. For example, the first arm 110 can be smaller in size than the second arm 112.

As shown in FIG. 5, in some embodiments, the first arm 110 can have length 202 while the second arm has length 204, wherein length 204 is greater than length 202. The widths of one or more portions of the second arm 112 can also be bigger than corresponding widths of one or more portions of the first arm 110.

Further, as shown in FIG. 5, the second bulbous end 124 can be larger (e.g., wider) than the first bulbous end 122. In alternate embodiments, the widths of the first and second bulbous ends 122 and 124 can be the same.

In some embodiments, the first arm 110 has the exemplary dimensions described above for the smaller sized device while the second arm 112 has the exemplary dimensions described above for the larger sized device.

In some embodiments, the first arm 110 of device 200 is sized to provide vaginal penetration and G spot stimulation for the first partner. This side is smaller than the other side, for a partner who prefers more shallow penetration.

In some embodiments, the second arm 112 of device 200 is sized to provide vaginal penetration for the second partner. This side is larger than the other side, for a partner who prefers more penetration.

In this way, the device 200 is a flexible (bendable), double-ended device that takes into account that both partners could want different amounts of penetration. For example, the device 200 can be customizable based on two partners' preferences and anatomy. The device 200 is configured to supplement and enable scissoring (not one wearer of one side stimulating another partner with the other side).

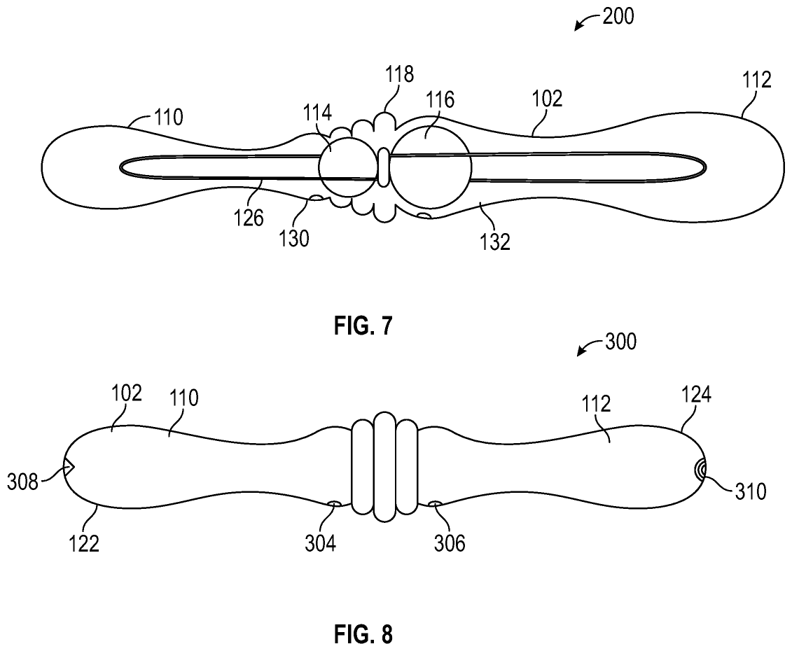

In some embodiments, as shown in FIG. 7, the first motor 114 and the second motor 116 can be sized proportionate to the size of the respective first arm 110 and second arm 112. For example, since the second arm 112 of device 200 is larger than the first arm 110, the second motor 116 can be larger in size than the first motor 114.

By making the second motor 116 larger, a thickness of the flexible polymeric (e.g., silicone) material of the body 102 between an outer surface of the body 102 and an outer surface of the second motor 116 can be approximately the same as the thickness of the material of the body 102 between the outer surface of the body 102 and an outer surface of the first motor 114. As such, the vibration of the second motor 116 is not dulled by a thicker material casing around the second motor.

The widths of the raised center elements 118 of device 200 can be configured differently than the raised center elements 118 of device 100 (e.g., ascending in width for device 200 vs. largest in the center for device 100) in order to bridge the size difference between the two sides of device 200, and still leave room to enable vulva-to-vulva contact between partners.

In some embodiments, the device 200 can be sized such that an overall length 206 is approximately 21.6 to 25.4 cm, the length 202 of the first partner's side is approximately 6.45 to 10.16 cm, the length 204 of the second partner's side is 15.24 to 18.9 cm, a width of the first bulbous end is approximately 1.27 to 2.54 cm, a width of the second bulbous end is approximately 1.27 to 2.54 cm, a narrowest width of the first arm 110 is approximately 0.64 to 1.91 cm, a narrowest width of the second arm 112 is approximately 1.91 to 3.18 cm, a width of the first bulbous region 130 is approximately 2.54 to 3.81 cm, a width of the second bulbous region 132 is approximately 2.54 to 3.81 cm, and a width of the largest ring 210 is approximately 3.18 to 4.45 cm.

FIGS. 8-20 show alternate embodiments of flexible, double-ended vibrating devices configured for two partners engaged in scissoring, which may be similar in one or more aspects to device 100 of FIGS. 1-4 and/or device 200 of FIGS. 5-7. Similar features to those of device 100 and/or device 200 are labeled similarly in FIGS. 8-20.

FIG. 8 shows a first alternate embodiment of a flexible, double-ended vibrating device 300 where the unique, identifying markers, including a first marker 308 and second marker 310 (differentiating between the different arms 110 and 112) are located at respective ends (e.g., bulbous ends 122 and 124) of the device 300. The first and second markers 308 and 310 can have different shapes or markings, as described above for the power buttons 104 and 106 of device 100. Further, in some embodiments, the markers 308 and 310 can be raised relative to the outer surface of the body 102. However, the device 300 may additionally include first and second power buttons 304 and 306 which function similar to power buttons 104 and 106 of device 100.

In some embodiments, the power buttons 304 and 306 may not have different shapes.

As shown in FIG. 8, the first marker 308 is shaped as a diamond and the second marker 310 is shaped as a ribbed bullseye. However, alternate differentiating shapes or patterns are possible, as described above.

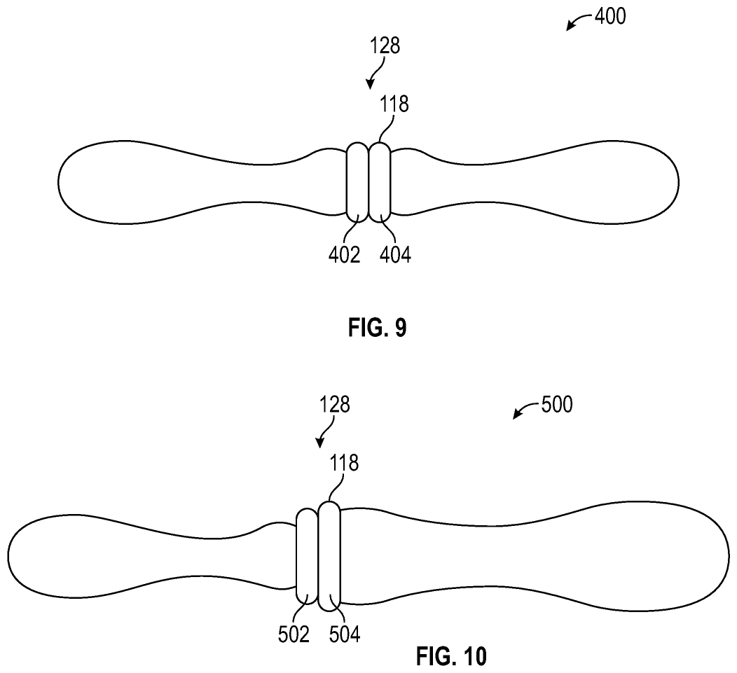

FIG. 9 shows a second alternate embodiment of a flexible, double-ended vibrating device 400 that is similar to device 100 of FIGS. 1-4, but the raised center elements 118 are configured as two central rings 402 and 404 (e.g., instead of one central ring and two side rings as shown in FIGS. 1-4).

FIG. 10 shows a third alternate embodiment of a flexible, double-ended vibrating device 500 that is similar to device 200 of FIGS. 5-7, but the raised center elements 118 are configured as two central rings 502 and 504.

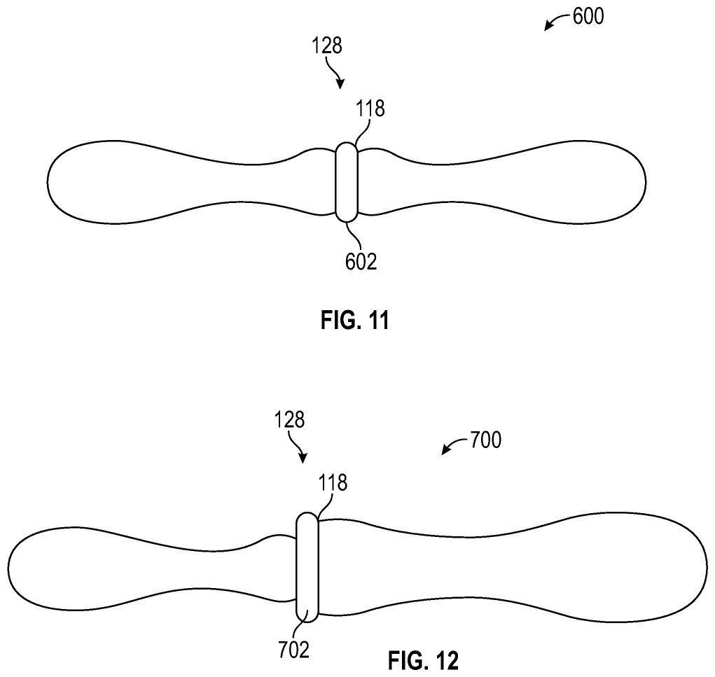

FIG. 11 shows a fourth alternate embodiment of a flexible, double-ended vibrating device 600 that is similar to device 100 of FIGS. 1-4, but the raised center elements 118 includes a single center element, which can be configured as a single, shared central ring 602. Thus, the shared central ring 602 (or alternate raised shared central element) can be configured to provide clitoral stimulation for both partners.

FIG. 12 shows a fifth alternate embodiment of a flexible, double-ended vibrating device 700 that is similar to device 200 of FIGS. 5-7, but the raised center elements 118 includes a single center element, which can be configured as a single, shared central ring 702. Thus, the shared central ring 702 (or alternate raised shared central element) can be configured to provide clitoral stimulation for both partners.

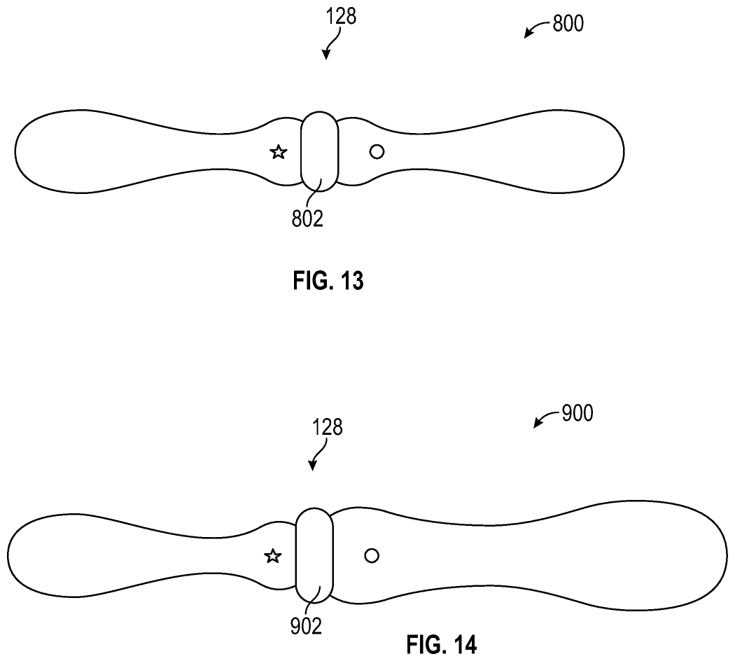

FIG. 13 shows a sixth alternate embodiment a flexible, double-ended vibrating device 800 that is similar to device 100 of FIGS. 1-4, but the raised center elements 118 is a single center element, which can be configured as a single, shared central bump 802 for added clitoral stimulation for both partners.

FIG. 14 shows a seventh alternate embodiment of a flexible, double-ended vibrating device 900 that is similar to device 200 of FIGS. 5-7, but the raised center elements 118 is a single center element, which can be configured as a single, shared central bump 902 for added clitoral stimulation for both partners.

FIG. 15 shows an eighth alternate embodiment of a flexible, double-ended vibrating device 1000 that is similar to device 100 of FIGS. 1-4, but the central portion 128 does not include any center raised elements separating (e.g., arranged between) the first and second arms 110 and 112 (e.g., there are no central rings or bumps).

FIG. 16 shows a ninth alternate embodiment of a flexible, double-ended vibrating device 1100 that is similar to device 200 of FIGS. 5-7, but the central portion 128 does not include any center raised elements separating (e.g., arranged between) the first and second arms 110 and 112 (e.g., there are no central rings or bumps).

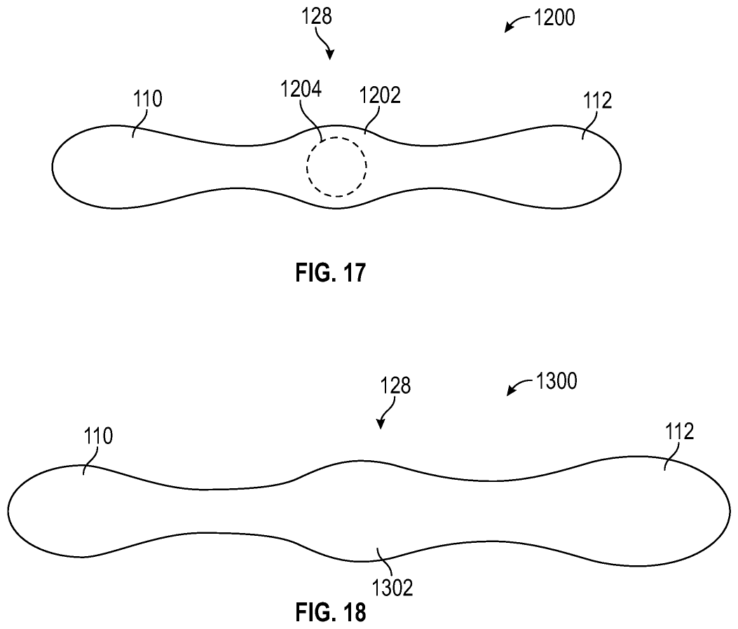

FIG. 17 shows a tenth alternate embodiment of a flexible, double-ended vibrating device 1200 that is similar to device 100 of FIGS. 1-4, but the central portion 128 of the device 1200 has a single bulbous region 1202 housing a single motor 1204 (shown with a dashed line to schematically illustrate is internal positioning) that is shared between the first and second arms 110 and 112 (and the two partners).

FIG. 18 shows an eleventh alternate embodiment of a flexible, double-ended vibrating device 1300 that is similar to device 200 of FIGS. 5-7, but the central portion 128 of the device 1300 has a single bulbous region 1302 housing a single motor that is shared between the first and second arms 110 and 112 (and the two partners).

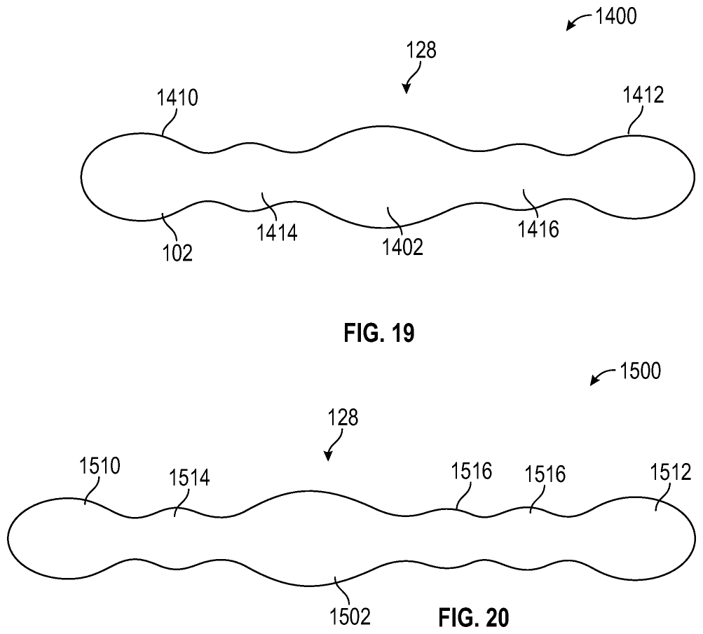

FIG. 19 shows a twelfth alternate embodiment of a flexible, double-ended vibrating device 1400 that is similar to device 100 of FIGS. 1-4, but the central portion 128 of the device 1400 has a single bulbous region 1402 housing a single motor that is shared between first and second arms 1410 and 1412 (and the two partners). The first and second arms 1410 and 1412 of device 1400 include additional bulbs 1414 and 1416 that are the solid material of the body 102 (e.g., solid silicone) and do not vibrate.

FIG. 20 shows a thirteenth alternate embodiment of a flexible, double-ended vibrating device 1500 that is similar to device 200 of FIGS. 5-7, but the central portion 128 of the device 1500 has a single bulbous region 1502 housing a single motor that is shared between first and second arms 1510 and 1512 (and the two partners). The first and second arms 1510 and 1512 of device 1500 include additional bulbs 1514 and 1516 that are the solid material of the body 102 (e.g., solid silicone) and do not vibrate.

In some embodiments, both arms (e.g., first arm 110 and second arm 112) of the various devices described above with reference to FIGS. 1-20, can have a same overall shape. For example, both arms 110 and 112 can have rounded, bulbous ends (e.g., ends 122 and 124) and curvature along their length that undulates, as described above. In some embodiments, both arms can additionally have a same size (e.g., in addition to having the same shape). In some embodiments, the two arms 110 and 112 may have different sizes (e.g., as shown in FIGS. 5-7), but the overall shape and ratio of the dimensions may remain the same (e.g., the arms are just different in scale).

In alternate embodiments, the two arms of the device (e.g., first arm 110 and second arm 112) can have different shapes. For example, differently shaped arms of the various embodiments disclosed herein can be combined to form a device having differently shaped arms (e.g., the first arm 110 of FIG. 17 can be combined with the second arm 112 of FIG. 19, with the central portion 128 arranged between, to form a device with differently shaped arms).

FIG. 21 shows an exemplary remote control device 1600 that can be configured to remotely control and adjust the operation of any of the flexible, double-ended vibrating devices described herein. In some embodiments, each partner can have their own remote 1600 that individually controls both sides (e.g., first arm 110 and second arm 112) of the device.

The remote 1600 can include a first side 1602 that is configured to control a first side (e.g., including first arm 110) of the device and a second side 1604 that is configured to control a second side (e.g., including second arm 112) of the device.

In alternate embodiments, a remote similar to remote 1600 can be configured to control only one side of the double-ended vibrating devices described herein. For example, a first remote can control a first side (e.g., including first arm 110) of the device and a separate, second remote can control a second side (e.g., including second arm 112) of the device. Such individual remotes can be configured similarly to remote 1600 (e.g., include similar buttons and functions), as described further below with reference to FIG. 21.

The first side 1602 of the remote 1600 includes a plurality of buttons 1606, 1608, and 1610 having a first differentiating marker or shape (e.g., star) that corresponds to the identifying shape on the power button 104 (e.g., as shown in FIG. 1) and/or the first marker 308 on an end of the first arm 110 (FIG. 8) of the device. In some embodiments, the buttons 1606, 1608, and 1610 can be raised, thereby providing tactile feedback that enables the user to know which side of the remote is theirs, without looking or in the dark. In some embodiments, the buttons 1606, 1608, and 1610 can additionally or alternatively light up.

The first button 1606 can be a power button that turns the first motor 114 (and/or a third motor 2004 in some alternate embodiments, as described below with reference to FIGS. 28, 30, and 34) on and off. The second button 1608 can be an intensity down button that lowers the intensity of vibration of the first motor 114 (and/or third motor 2004) by cycling down through multiple intensity levels. The third button 1610 can be an intensity up button that raises the intensity of vibration of the first motor 114 (and/or third motor 2004) by cycling up through multiple intensity levels.

Similarly, the second side 1604 of the remote 1600 includes a plurality of buttons 1612, 1614, and 1616 having a second differentiating marker or shape (e.g., circle) that corresponds to the identifying shape on the power button 106 (e.g., as shown in FIG. 1) and/or the second marker 310 on an end of the second arm 112 (FIG. 8) of the device. In some embodiments, the buttons 1612, 1614, and 1616 can be raised, thereby providing tactile feedback that enables the user to know which side of the remote is theirs, without looking or in the dark. In some embodiments, the buttons 1612, 1614, and 1616 can additionally or alternatively light up.

The first button 1612 can be a power button that turns the second motor 116 (and/or a fourth motor 2006 in some alternate embodiments, as described below with reference to FIGS. 28, 30, and 34) on and off. The second button 1614 can be an intensity down button that lowers the intensity of vibration of the second motor 116 (and/or fourth motor 2006) by cycling down through multiple intensity levels. The third button 1616 can be an intensity up button that raises the intensity of vibration of the second motor 116 (and/or fourth motor 2006) by cycling up through multiple intensity levels.

FIGS. 22A and 22B show an embodiment of an inductive charging system 1700 for any of the flexible, double-ended vibrating devices described herein (device 100 is shown in FIG. 22A as an example, though the system can be adapted to any of the other devices described herein). As shown in FIG. 22A, an inductive charger 1702 can be connected to the charger port 148 of the device 100. For example, in some embodiments, the inductive charger 1702 can be a disk-shaped inductive charger that connects magnetically to the charger port 148 and charges through a thin silicone barrier between the charger port 148 and an outer surface of the body 102 (FIG. 22A). In some embodiments, the device 100 power buttons may light up when connected to the charger so users know it is charging.

The inductive charger can be coupled to a power source 1706 by a charger cable 1704 (FIG. 22A).

FIG. 22B shows a schematic 1710 of a side view of the inductive charger 1702, configured as a disk.

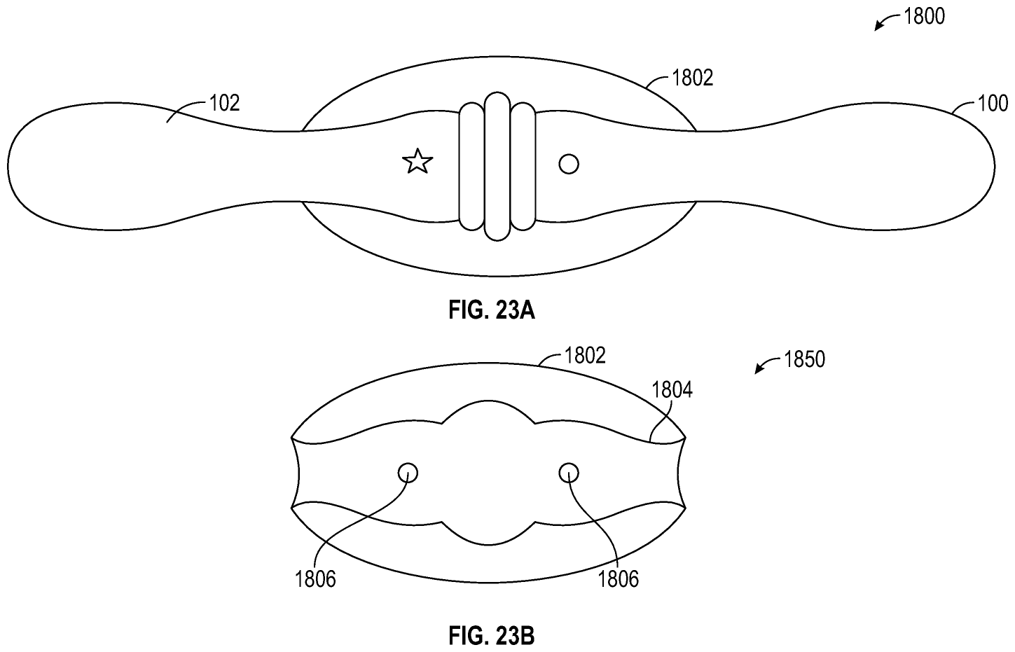

FIGS. 23A and 23B show another embodiment of an inductive charging system 1800 for any of the flexible, double-ended vibrating devices described herein (device 100 is shown in FIG. 23 as an example). The inductive charging system 1800 can include an inductive charger cradle 1802 in which the device 100 rests while charging (FIG. 23A).

In some embodiments, the device 100 power buttons may light up when connected to the charger cradle 1802 so users know it is charging

The charger cradle 1802 can connect to a charger port on the underside (as shown in FIG. 23A) of the device 100 (e.g., charger port 148 shown in FIG. 3), through the body 102 of the device 100.

FIG. 23B shows a schematic 1850 of a view of the empty inductive charger cradle 1802. In some embodiments, as shown in FIG. 23B, the inductive charger cradle can include a molded indentation 1804 in its interior where the device 100 can be received (and rest) within. The inductive charger cradle 1802 can further include one or more inductive charging connections 1806 (e.g., one for each charger port of the device 100, which, in some embodiments, may include one charger port and one corresponding charging connection for each motor of the device 100 or one charger port and one corresponding charging connection for both or all motors, or a single motor, of the device 100).

FIG. 24A shows another embodiment of an inductive charging system 1900 for any of the flexible, double-ended vibrating devices described herein (device 1200 is shown in FIG. 24A as an example). The inductive charging system 1900 can include a charger box 1902 including a base 1904 and a top 1906. The base 1904 of the charger box 1902 can be molded (and shaped) to fit a flexible, double-ended vibrating device 1920 (e.g., such as device 1200 or any of the other devices disclosed herein) therein for storage. In some embodiments a depression in the base 1904 can be shaped to have a corresponding shape to the intended device (e.g., device 1200) to be received therein. There may be no current in the base 1904.

The top 1906 of the box 1902 can be configured to charge the device 1920 and the corresponding remotes 1908 and 1910 (which may be the same as or similar to remote 1600 of FIG. 21) via three inductive charger connections, one on the underside for the device 1920 and two on the exterior top side for the remotes 1908 and 1910. The interior of the top 1906 can be molded (and shaped) to fit the device 1920 therein.

In some embodiments, the remotes 1908 and 1910 can have inductive charger ports located on the backs of the remotes. Thus, the remotes 1908 and 1910 are configured to charge by resting atop the box top (e.g., cover) 1906, as shown in FIG. 24A. For example, the top 1906 can include inductive charger connections 1912 that are configured to electrically connect to the inductive charger ports on the remotes 1908 and 1910.

In some embodiments, the top 1906 can further include an inductive charger connection 1914 configured to electrically connect to the charger port (e.g., charger port 148 shown in FIG. 3) on the device 1920 for charging the device 1920.

FIG. 24B shows a schematic 1950 of an exemplary top view of the inductive charging system 1900, showing a top of each of the remotes 1908 and 1910 which face outward and are configured to rest on top of the top 1906 of the box 1902.

In some embodiments, the interior cavities (e.g., depressions) of the box 1902 can be molded perfectly to hold a selected device (e.g., selected shape and size) therein.

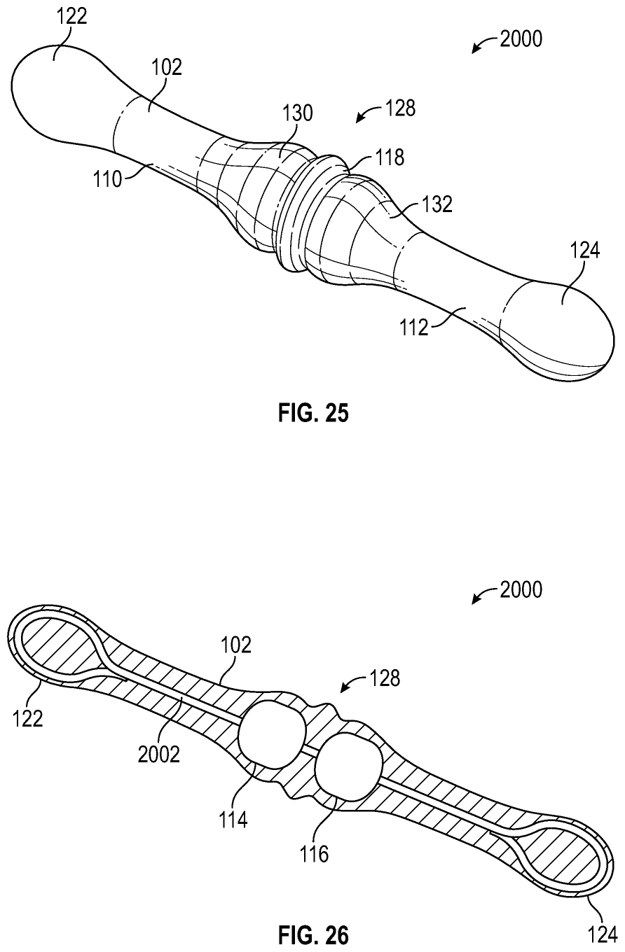

FIGS. 25-34 show additional embodiments of flexible, double-ended vibrating devices which may be similar to one or more of the devices described above. For example, FIG. 25 shows an exterior view of an exemplary flexible, double-ended vibrating device 2000, which may be similar to the device 100 (FIGS. 1-4), except for a configuration of its central portion 128. For example, the device 2000 can comprise a body 102 and a first arm 110 and second arm 112 extending outward from a central portion 128 of the device 2000. In contrast to the device 100 of FIGS. 1-4, the central portion 128 of the device 2000 can comprise a single raised center element 118 (shown as a ring in FIG. 25). In other embodiments, the central portion 128 of device 2000 can comprise more than the single center element 118, such as two or three center elements (e.g., as shown in FIGS. 1-4).

It should be noted that the lighter curved lines shown in FIG. 25 are contour and/or shading lines used to illustrate the contours and curves of the device 2000. However, it should be noted that an outer surface of the body 102 of the device 2000 can be smooth and continuous and these contour/shading lines are not meant to portray segmentation of the device 2000.

In some embodiments a width (or diameter, e.g., width 140 shown in FIG. 1) of the bulbous ends 122 and 124 of the device 2000 can be a same or similar width as the first bulbous region 130 and the second bulbous region 132 of the device 2000. In other embodiment, the width of the bulbous ends 122 and 124 can be larger or smaller than the width of the first bulbous region 130 and the second bulbous region 132.

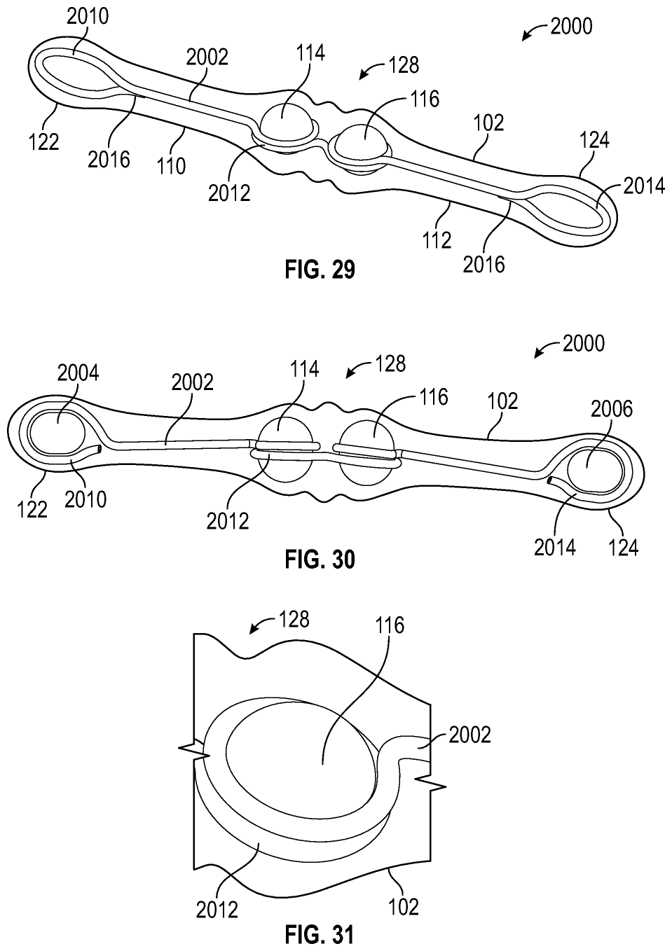

The device 2000 can comprise one or more vibrating motors (also referred to herein as vibrators) that can be fully or at least partially internalized within the body 102 of the device 2000, as shown in FIGS. 26-31 and 34. For example, FIGS. 26-31 and 34 show various exemplary arrangements of the one or more vibrating motors and a flexible element 2002 arranged (or encased or enclosed) within an interior of the body 102 of the device 2000. While FIGS. 26-28 show cross-sectional views of the device 2000 with different configurations of the internal components, FIGS. 29-31 and 34 present transparent views that show an outline of the body 102 and the different configurations of the internal components within the transparent body.

As shown in FIGS. 26-28, the body 102 can comprise a polymeric material (such as silicone) that extends from an outer surface of the body 102 into an interior of the body 102 and encases or encloses therein the flexible element 2002 and the one or more vibrating motors. For example, in some embodiments, the polymeric material of the body 102 can be formed or molded around (e.g., via injection molding) the internal flexible element 2002 and one or more vibrating motors.

In some embodiments, the flexible element 2002 can be configured as a wire, such as the wire 126 described above with reference to FIG. 3. In some embodiments, the flexible element 2002 can comprise a metal wire. Further, in some embodiments, the vibrating motors described below with reference to FIGS. 26-33 can be the same or similar to, and function the same or similar to, the motors 114 and 116, as described above (and shown in FIG. 3).

In some embodiments, the flexible element 2002 can be single continuous element (e.g., wire) that extends from a first end 122 of the device 2000 to a second end 124 of the device 2000 and wraps, curves, loops, twists, or otherwise extends around and between the one or more vibrating motors contained within the body 102 of the device 2000.

In some embodiments, the flexible element 2002 can be one or more flexible elements (e.g., wires) that are coupled and continuous with one another (e.g., via welding or twisting together) from a first end 122 of the device 2000 to a second end 124 of the device 2000 and that wrap, curve, loop, twist, or otherwise extend around and between the one or more vibrating motors contained within the body 102 of the device 2000.

In some embodiments, as shown in FIGS. 26 and 29, the device 2000 can comprise two vibrating motors, including the first motor 114 and the second motor 116, disposed in the central portion 128 of the device 2000. As disclosed above, the first motor 114 and second motor 116 can be controlled (e.g., actuated) separately. In some embodiments, the first motor 114 and the second motor 116 can be configured to provide vibrations along the flexible element 2002 within the first arm 110 and the second arm 112, respectively.

In other embodiments, as shown in FIGS. 27 and 30, the device 2000 can comprise four vibrating motors, including the first motor 114 and the second motor 116 disposed in the central portion 128 of the device 2000, as well as a third motor 2004 disposed in the first end 122 and a fourth motor 2006 disposed within the second end 124 of the device 2000.

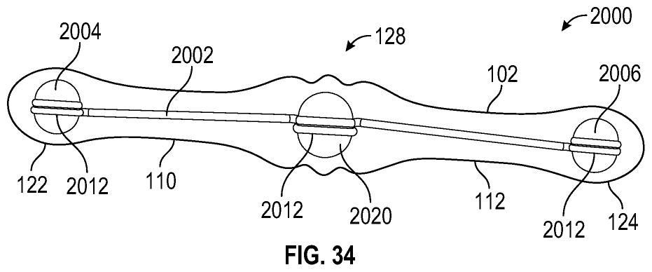

In other embodiments, as shown in FIG. 34, the device 2000 can comprise three vibrating motors, including a single central motor 2020 (which may be similar to the first motor 114 or second motor 116) disposed in the central portion 128 of the device 2000, as well as the third motor 2004 disposed in the first end 122 and the fourth motor 2006 disposed within the second end 124 of the device 2000.

In other embodiments, as shown in FIG. 28, the device 2000 can comprise two vibrating motors, including the third motor 2004 disposed in the first end 122 and the fourth motor 2006 disposed within the second end 124 of the device 2000. In such embodiments, the device 2000 may not include motors within the central portion 128, and instead, the flexible element 2002 can extend around each of the third motor 2004 and the fourth motor 2006 and between the third motor 2004 and fourth motor 2006 (e.g., through a center of the device 2000) (FIG. 28).

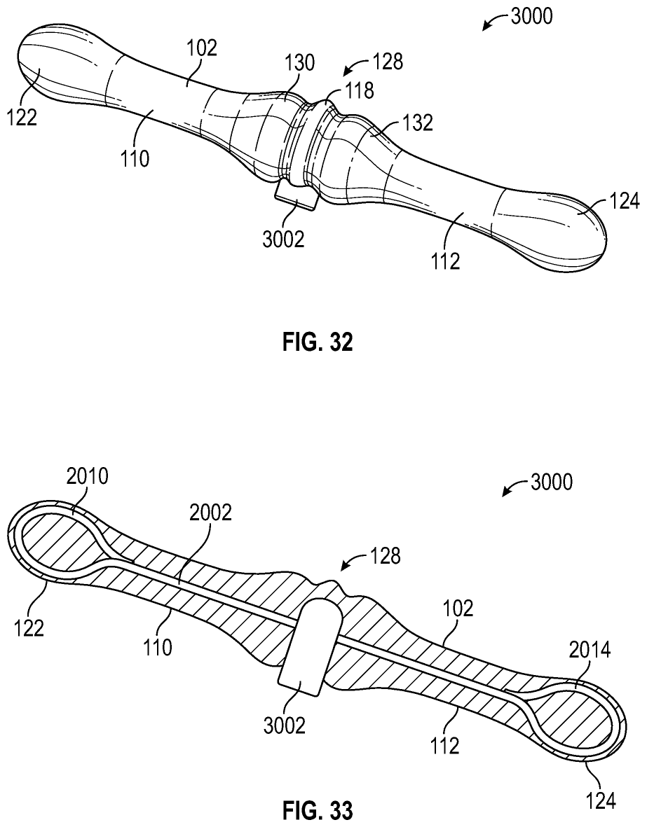

In other embodiments, the device 2000 can comprise a single motor disposed in the central portion 128 (e.g., centered in the central portion, such as shown schematically in FIG. 17 and also shown in FIG. 34). For example, FIGS. 32 and 33 illustrate an embodiment of a flexible, double-ended vibrating device 3000 that comprises a single motor 3002 disposed in the central portion 128. The device 3000 can be similar to device 2000, except that its single motor 3002 can be removable from the body 102 of the device 3000. For example, as shown in FIGS. 33 and 34, the motor 3002 is at least partially contained within an interior of the body 102 but extends outside of the body 102 in the central portion 128. In other embodiments, the single motor of the device 3000 may not be removable and may instead be fully contained within the body 102 (e.g., as shown in FIGS. 26, 27, 29, 30, and/or 34).

As shown in FIGS. 3, 26-31, and 34, the routing of the wire 126 or flexible element 2002 (e.g., wire) around the one or more motors of the device 100 or 2000 can include wrapping, twisting, curving, or looping around the one or more motors in various ways. Further, the routing of the wire 126 or flexible element 2002 inside the body 102 of the device 100 or 2000 and within the ends 122 and 124 of the device 100 or 2000 can vary. In some embodiments, the wire 126 or flexible elements 2002 described below can be a single, continuous bendable wire or flexible element with opposing ends (e.g., free ends).

In some embodiments, as shown in FIG. 3, the wire 126 can begin and end in the central portion 128 of the device 100, in a space between the two central vibrating motors 114 and 116. The wire 126 can be housed in the body 102 (e.g., within the material, such as silicone, of the body 102), and the (free) ends of the wire 126 can meet together at the center of the device 100 (within the central portion 128). In some embodiments, the ends of the wire 126 can meet at a connection interface 150, which can be configured as a cap, sheath, glue, or the like, surrounding them. Such a connection interface 150 can provide extra reinforcement to keep the ends of the wire 126 from migrating within the material of the body 102 due to normal use and wear. In some embodiments, as shown in FIG. 3, a path of the wire 126 can appear as a “figure 8.” For example, one end of the wire 126 can begin at the center of the central portion 128, travel around one side of the first motor 114, off center toward the first end 122 of the first arm 110, and then can loop back and travel off center through the first arm 110 in a parallel path, and extend around the other side of the first motor 114. The wire 126 can then cross the center in between the two motors 114 and 116 to then travel around the opposite side of the second motor 116, off-center through the interior body of the second arm 112. The wire 126 can then loop around near the second end 124 and travel back toward the center in a parallel path. The wire 126 can then extend around the other side of the second motor 116 and toward the center to end where it began (e.g., at the connection interface).

In some embodiments, the wire 126 can contact one or more of the motors 114 and 116. In some embodiments, the wire 126 may not contact either of the motors 114 and 116, and in some embodiments, a material of the body 102 (e.g., silicone) can be disposed between at least a portion of one or more of the motors 114 and 116 and the wire 126. In some embodiments, the wire 126 can be configured to carry vibration from the motors 114 and 116 through the body 102 of the device 100 (e.g., to the ends 122 and 124). As a result, the central motors 114 and 116, with the wire 126, can provide both clitoral simulation (at the central portion 128) and G spot or vaginal stimulation (at the ends 122 and 124), for each partner.

In other embodiments, the wire 126 may not carry vibration from the motors 114 and 116 to the ends 122 and 124 of the device 100 (e.g., an instead the vibrations from the motors 114 and 116 can be localized to the central portion 128 of the body surrounding the motors 114 and 116).

In some embodiments, as shown in FIGS. 29 and 30, the flexible element 2002 can begin in a first loop 2010 within the interior of the first end 122 of the body 102 and can then travel along a center portion of the first arm 110 (e.g., along a central longitudinal axis of the device 2000 in some embodiments) toward the first motor 114. The flexible element 2002 can then wrap or coil around the first motor 114 one or more times such that one or more coils 2012 are formed around the first motor 114. The flexible element 2002 can then cross through the center of the device 2000 to the other side of the second motor 116 and then wrap or coil around the second motor 116 one or more times such that one or more coils 2012 are formed around the second motor 116 (FIGS. 29-31). The flexible element 2002 can then travel (extend) along the center portion of the second arm 112 toward the second end 124 and then finish in a second loop 2014 within the second end 124 of the body 102 (FIGS. 29 and 30).

In some embodiments, one or both of the first loop 2010 and the second loop 2014 can be closed loops such that free ends 2016 of the flexible element 2002 are not freely extending out into the material of the body 102. In some embodiments, the free ends 2016 of the flexible element 2002, at the first loop 2010 and the second loop 2014, can be attached to another portion of the flexible element 2002 (e.g., the relatively straight portion extending through the arms 110 and 112). In some embodiments, the free ends 2016 of the flexible element 2002 can be attached to the additional portions of the flexible element 2002 extending along the arms 110 and 112 via a cap, sheath, tape, glue, or the like. The loops 2010 and 2014, and in some embodiments the attaching material, can provide extra reinforcement to keep the free ends 2016 from migrating within the material of the body 102 due to normal use and/or wear.

In other embodiments, one or both of the first loop 2010 and the second loop 2014 can be open loops such that free ends 2016 of the flexible element are spaced away from another portion of the flexible element 2002 (e.g., as shown in FIG. 30). In such embodiments, a material (e.g., polymeric material, such as silicone) of the body 102 can separate the free ends 2016 from another nearest portion of the flexible element 2002 (e.g., the relatively straight portion extending through the arms 110 and 112).

In some embodiments, the first loop 2010 and the second loop 2014 can be larger or smaller than shown in FIG. 29. For example, in some embodiments, the first loop 2010 and/or the second loop 2014 can be smaller in diameter, or instead of looping, the flexible element 2002 can coil or loop multiple times within the first end 122 and/or second end 124.

The flexible element 2002 can coil around each of the central motors 114 and 116 any number of times, thereby forming one or more coils 2012. For example, as shown in FIGS. 29-31, there may be two coils 2012 formed around each central motor. However, in other embodiments, the flexible element 2002 can form one, three, or partial coils (e.g., 1.5 coils) 2012 around one or more of the central motors.

Whether coiled around, looped around, or traveling alongside any of the motors described herein (e.g., as described further below), the flexible element 2002 (or wire) may or may not be touching any of the motors. For example, in some embodiments, the flexible element 2002 (e.g., the coils 2012) can directly contact an outer surface of one or more of the motors. In such embodiments, the flexible element 2002 may be configured to carry the vibrations of the motor which it is contacting along and/or through a portion of the body 102 of the device 2000. In other embodiments, the flexible elements 2002 (e.g., the coils 2012) may not directly contact the outer surface of one or more of the motors. Thus, in some embodiments, there may or may not be silicone from the body's interior between the flexible element 2002 and one or more of the motors.

In embodiments where the device 2000 comprises motors in the ends 122 and 124 of the device (FIGS. 27, 28, and 30), the first loop 2010 can loop around (or encircle) the third motor 2004 and the second loop 2014 can loop around the fourth motor 2006. In some embodiments, the first loop 2010 and/or the second loop 2014 can directly contact the outer surface of the third motor 2004 and/or the fourth motor 2006, respectively. For example, as shown in FIG. 30, the first loop 2010 and the third motor 2004 can be spaced apart from one another (and in some embodiments the space can be filled with a material of the body 102, such as silicone, or by air, as shown in FIGS. 27 and 28). However, in other embodiments, at least a portion of the first loop 2010 can be contacting the outer surface of the third motor 2004 (e.g., such that no material of the body 102 separates the loop of the flexible element 2002 from the motor which it loops around). For example, though FIGS. 27 and 28 show the material of the body 102 disposed between the looped ends of the flexible element 2002 and motors 2004 and 2006, in alternate embodiments, there may be no material between the looped ends of the flexible element 2002 and the motors 2004 and 2006. Further, in some embodiments, the looped ends of the flexible element 2002 may be contacting the motors 2004 and 2006 all the way around an outer surface of the motors 2004 and 2006 (and thus no intervening material may be present between the looped ends of the flexible element 2002 and the motors 2004 and 2006).

In some embodiments, the flexible element 2002 can loop or coil (e.g., as shown in FIG. 34) around the end motors 2004 and 2006 more than once (e.g., such as two or three times), thereby forming one or more coils 2012 around the respective motors (e.g., two show around motors 2004 and 2006 in FIG. 34).

In other embodiments, as shown in the cross-sectional views of FIGS. 26 and 27 (the cross-sections taken through a center the device 2000 and the motors), instead of looping or coiling around the central motors 114 and 116, the flexible element 2002 can extend around the central motors 114 and 116 in an “S” or “m” shaped curve. For example, in some embodiments, from the first arm 110, the flexible element 2002 can extend around one side of the first motor 114 (e.g., behind in the drawing views of FIGS. 26 and 27), cross through the center of the device between the first and second motors 114 and 116, and then extend around an opposite side of the second motor 116 (e.g., in front in the drawing views of FIGS. 26 and 27) (e.g., in an “S” pattern). In other embodiments, from the first arm 110, the flexible element 2002 can extend around one side of the first motor 114 (e.g., behind in the drawing views of FIGS. 26 and 27), cross or extend through the center of the device between the first and second motors 114 and 116, and then extend around the same side of the second motor 116 (e.g., behind) (e.g., in the curves of a “B” or a “m”).

Though the flexible element 2002 is shown contacting the motors 114 and 116 in FIGS. 26 and 27, in other embodiments, the flexible element 2002 can be spaced away (and not contacting) at least a portion of one or more of the motors 114 and 116. For example, in some embodiments, a portion of the wire extending between the first motor 114 and the second motor 116 can be spaced away from the first motor 114 and the second motor 116.

In still other embodiments, the flexible element 2002 can twist or partially loop around one or more of the central motors 114 and 116 to pass around the motors and through the central portion 128 of the device 2000.

In some embodiments, when the device 2000 includes a central motor that is internal (arranged entirely within an interior of the body 102), such as shown in FIG. 17 and similar to the two central motors of FIGS. 26 and 29, the flexible element 2002 can be routed in a similar fashion as described above with reference to FIGS. 26 and 29. However, instead of extending between two central motors, the flexible element 2002 can extend from each of the loops 2010 and 2014 to the central motor and then coil, twist, or extend alongside the single motor in any of the ways described above and shown in FIGS. 3 and 26-31.

In other embodiments, when the device 2000 includes the removable central motor 3002 (FIGS. 32 and 33), the flexible element 2002 can begin in the first loop 2010 within the interior of the first end 122 of the body 102 and can then travel along the center portion of the first arm 110 (e.g., along a central longitudinal axis of the device 2000 in some embodiments) toward the central motor 3002. The flexible element 2002 can then wrap or coil, within a material of the body 102 around an opening where the central motor 3002 is received, or curve alongside the opening. The flexible element 2002 can then travel within the interior of the second arm 112 to the second end 124.

Any of the embodiments of the flexible, double-ended vibrating device described herein can be configured to comprise removable motors (e.g., in place of the disclosed internal motors).

Further, any of the other devices disclosed herein can include routing of the internal wire(s) or flexible element(s), around the one or more motors of the device and through the device, similar to that of one or more of the examples described above with reference to FIGS. 26-31 and 33-34.

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

As used in this application the singular forms “a,” “an,” and “the” include the plural forms unless the context clearly dictates otherwise. Additionally, the term “includes” means “comprises.” Furthermore, as used herein, the term “and/or” means any one item or combination of items in the phrase. In addition, the term “exemplary” means serving as a non-limiting example, instance, or illustration. As used herein, the terms “e.g.” and “for example” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For the purposes of this disclosure, relative terms such as “vertical”, “horizontal”, “top”, “bottom”, “front”, “back”, “end” and “sides” may be used. It should be understood, however, that the terms are used only for purposes of description and are not intended to be used as limitations. Accordingly, the orientation of an object or a combination of objects may change without altering the scope of the claimed subject matter.

### Additional Examples of the Disclosed Technology

In view of the above described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A device comprising: two flexible arms, each arm of the two flexible arms extending outward from an opposite side of a central portion of the device and having a same shape, at least one arm of the two flexible arms configured to individually bend into a plurality of bent positions and retain a selected bent position until bent into another selected bent position; and at least one vibrating motor arranged within the central portion.

Example 2. The device of any example herein, particularly example 1, wherein both arms of the two arms are configured to individually bend into the plurality of bent positions and retain a selected bent position until bent into another selected bent position.

Example 3. The device of any example herein, particularly any one of examples 1-2, wherein each arm is symmetric around a central longitudinal axis of the arm, the central longitudinal axis extending from a free end of the arm to the central portion.

Example 4. The device of any example herein, particularly any one of examples 1-3, wherein the central portion has a width that is larger than a width of a portion of at least one arm of the two arms arranged adjacent to the central portion.

Example 5. The device of any example herein, particularly any one of examples 1-4, further comprising a body comprising a flexible polymeric material and one or more interior wires extending through the two arms.

Example 6. The device of any example herein, particularly any one of examples 1-5, wherein each arm includes a bulbous end arranged away from the central portion, the bulbous end having a width that is larger than a width of a portion of the arm arranged between the bulbous end and the central portion.

Example 7. The device of any example herein, particularly any one of examples 1-6, wherein the device includes two individually controllable vibrating motors and wherein a first arm of the two arms includes a bulbous region disposed in the central portion, around a first motor of the two motors, the bulbous region having a width that is larger than a width of a portion of the first arm arranged adjacent to the central portion.

Example 8. The device of any example herein, particularly example 7, wherein a second arm of the two arms includes a bulbous region disposed in the central portion, around a second motor of the two motors, the bulbous region having a width that is larger than a width of a portion of the second arm arranged adjacent to the central portion.

Example 9. The device of any example herein, particularly example 8, wherein the central portion includes one or more raised elements arranged between the bulbous region of each of the first arm and the second arm and that extend radially outward relative to each bulbous region of each of the first arm and the second arm, and relative to a central longitudinal axis of the device, wherein the one or more raised elements are configured to vibrate.

Example 10. The device of any example herein, particularly any one of examples 1-9, wherein at least one arm of the two arms includes an identifying marker.

Example 11. The device of any example herein, particularly example 10, wherein the identifying marker is configured as a power button.

Example 12. The device of any example herein, particularly any one of examples 1-9, wherein each arm includes a different, identifying marker.

Example 13. The device of any example herein, particularly example 12, wherein the identifying marker of each arm is configured as a power button.

Example 14. The device of any example herein, particularly any one of examples 1-6 or 10-13, wherein the at least one vibrating motor includes a single vibrating motor that is removable from the central portion.

Example 15. A device comprising: two flexible arms extending outward from opposite sides of a central portion of the device, at least one arm of the two flexible arms configured to individually bend into a plurality of bent positions and retain a selected bent position until bent into another selected bent position; and two individually vibrating motors configured to be individually controlled, each motor of the two individually vibrating motors arranged within a region of a corresponding arm of the two arms that is disposed in the central portion.

Example 16. The device of any example herein, particularly example 15, wherein both arms of the two arms are configured to individually bend into the plurality of bent positions and retain a selected bent position until bent into another selected bent position.

Example 17. The device of any example herein, particularly any one of examples 15-16, wherein a region of a first arm of the two arms that is disposed in the central portion and contains a first motor of the two motors has a width that is larger than a width of a portion of the first arm arranged adjacent to the central portion.

Example 18. The device of any example herein, particularly example 17, wherein a region of a second arm of the two arms that is disposed in the central portion and contains a second motor of the two motors has a width that is larger than a width of a portion of the second arm arranged adjacent to the central portion.

Example 19. The device of any example herein, particularly any one of examples 15-18, further comprising a body comprising a flexible polymeric material and one or more interior wires extending through the two arms.

Example 20. The device of any example herein, particularly example 19, wherein the one or more interior wires comprises a single continuous wire with free ends that are arranged into a loop at a free end of each arm of the two flexible arms.

Example 21. The device of any example herein, particularly any one of examples 15-20, wherein each arm includes a free end, spaced away from the central portion, and wherein the free end of at least one arm of the two arms has a width that is larger than a width of a portion of the at least one arm arranged between the free end and the central portion.

Example 22. The device of any example herein, particularly example 21, wherein the free end of each arm of the two arms has a width that is larger than a width of a portion of the arm that is arranged between the free end and the central portion.

Example 23. The device of any example herein, particularly any one of examples 15-22, wherein a first arm of the two arms includes a first power button configured to control a first motor of the two motors.

Example 24. The device of any example herein, particularly example 23, where a second arm of the two arms includes a second power button configured to control a second motor of the two motors.

Example 25. The device of any example herein, particularly example 24, wherein the first power button has a first raised shape and the second power button has a second raised shape, the second raised shape different from the first raised shape.

Example 26. The device of any example herein, particularly any one of examples 15-25, wherein the central portion includes one or more raised elements arranged between the region of each arm that the motors are arranged within, and that extend radially outward relative to each region of each arm, and relative to a central longitudinal axis of the device, wherein one or more of the one or more raised elements are configured to vibrate.

Example 27. The device of any example herein, particularly example 26, wherein the one or more raised elements are configured as rings extending around a circumference of the central portion.

Example 28. A device comprising: two flexible arms extending outward from opposite sides of a central portion of the device, both arms of the two arms configured to individually bend into a plurality of bent positions and retain a selected bent position until bent into another selected bent position; and two individually vibrating motors configured to be individually controlled, each motor of the two individually vibrating motors arranged within a corresponding arm of the two arms.

Example 29. The device of any example herein, particularly example 28, further comprising a body comprising a flexible polymeric material and one or more interior wires extending continuously through the two arms and around the two individually vibrating motors.

Example 30. The device of any example herein, particularly example 29, wherein the one or more interior wires comprises a single, continuous wire that extends from a first end of the device to a second end of the device and that extends around the two individually vibrating motors.

Example 31. The device of any example herein, particularly example 30, wherein the single continuous wire coils around each of the two individually vibrating motors one or more times and extends between the two individually vibrating motors.

Example 32. The device of any example herein, particularly any one of examples 28-31, where a first arm of the two flexible arms has a first size and a second arm of the two flexible arms has a second size, the second size larger than the first size.

Example 33. The device of any example herein, particularly example 32, wherein the first size includes a first length and first width and the second size includes a second length and second width.

Example 34. The device of any example herein, particularly any one of examples 32-33, wherein the first arm and the second arm have a same shape but are different in scale.

Example 35. The device of any example herein, particularly any one of examples 28-34, wherein the central portion comprises one or more raised elements that extend radially outward relative to a central longitudinal axis of the device and around a circumference of the device.

Example 36. The device of any example herein, particularly example 35, wherein the one or more raised elements are disposed between the two individually vibrating motors in an axial direction.

Example 37. The device of any example herein, particularly any one of examples 28-36, wherein the two individually vibrating motors comprise a first motor and a second motor, each of the first motor and the second motor disposed within a region of a corresponding arm of the two arms that is disposed in the central portion and further comprising a third motor disposed in a distal, free end of a first arm of the two arms and a fourth motor disposed in a distal, free end of a second arm of the two arms.

Example 38. The device of any example herein, particularly any one of examples wherein the two individually vibrating motors comprise a first motor that is disposed in a distal, free end of a first arm of the two arms and a second motor disposed in a distal, free end of a second arm of the two arms and further comprising a third motor disposed in the central portion.

Example 39. The device of any example herein, particularly example 37, wherein the first arm of the two arms includes a first power button configured to control the first motor and the third motor.

Example 40. The device of any example herein, particularly either example 37 or example 39, wherein the second arm of the two arms includes a second power button configured to control the second motor and the fourth motor.

Example 41. A device comprising: two flexible arms extending outward from opposite sides of a central portion of the device and configured to individually bend into a plurality of bent positions and retain a selected bent position until bent into another selected bent position, the two flexible arms comprising: a first arm having a first shape and first size; a second arm having the first shape and a second size, the second size being larger or smaller in scale than the first size; and at least one vibrating motor.

Example 42. A device comprising: two flexible arms extending outward from opposite sides of a central portion of the device, both arms of the two arms configured to individually bend into a plurality of bent positions and retain a selected bent position until bent into another selected bent position; a first vibrating motor arranged in the central portion; a second vibrating motor disposed in a distal, free end of a first arm of the two arms; and a third vibrating motor disposed in a distal, free end of a second arm of the two arms.

In view of the many possible embodiments to which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. A device comprising:
two flexible arms, each arm of the two flexible arms extending outward from an opposite side of a central portion of the device and having a same shape, at least one arm of the two flexible arms configured to individually bend into a plurality of bent positions and retain a selected bent position until bent into another selected bent position, wherein the two flexible arms and the central portion are formed by a body and one or more flexible elements extending within an interior of the body; and
at least one vibrating motor arranged within the central portion, within the interior of the body.

2. The device of claim 1, wherein both arms of the two arms are configured to individually bend into the plurality of bent positions and retain a selected bent position until bent into another selected bent position, and wherein the one or more flexible elements extend between a first free end of a first arm of the two arms and a second free end of a second arm of the two arms, the first and second free ends each spaced away from the central portion.

3. The device of claim 1, wherein the central portion has a width that is larger than a width of a portion of at least one arm of the two arms arranged adjacent to the central portion.

4. The device of claim 1, wherein the body comprises a flexible polymeric material and has a continuous outer surface along the two arms and the central portion, and wherein the one or more flexible elements extend through the two arms and the central portion.

5. The device of claim 1, wherein each arm includes a bulbous end arranged away from the central portion, the bulbous end having a width that is larger than a width of a portion of the arm arranged between the bulbous end and the central portion, and wherein the one or more flexible elements comprise a wire, and wherein the wire forms a loop within the bulbous end of each arm.

6. The device of claim 1, wherein the device includes two individually controllable vibrating motors disposed within the interior of the body, wherein a first arm of the two arms includes a bulbous region disposed in the central portion, around a first motor of the two motors, the bulbous region of the first arm having a width that is larger than a width of a portion of the first arm arranged adjacent to the central portion, and wherein a second arm of the two arms includes a bulbous region disposed in the central portion, around a second motor of the two motors, the bulbous region of the second arm having a width that is larger than a width of a portion of the second arm arranged adjacent to the central portion.

7. The device of claim 6, wherein the central portion includes one or more raised elements arranged between the bulbous region of each of the first arm and the second arm and that extend radially outward relative to each bulbous region of each of the first arm and the second arm, and relative to a central longitudinal axis of the device, wherein the one or more raised elements are configured to vibrate.

8. The device of claim 1, wherein at least one arm of the two arms includes an identifying marker, and wherein a free end of each arm that is spaced away from the central portion is configured to vibrate.

9. A device comprising:
two flexible arms extending outward from opposite sides of a central portion of the device, at least one arm of the two flexible arms configured to individually bend into a plurality of bent positions and retain a selected bent position until bent into another selected bent position, wherein the two flexible arms and the central portion are formed by a body and one or more flexible elements extending continuously through the two arms and the central portion within an interior of the body; and
two individually vibrating motors configured to be individually controlled, each motor of the two individually vibrating motors arranged within a region of a corresponding arm of the two arms that is disposed in the central portion, within the interior of the body.

10. The device of claim 9, wherein both arms of the two arms are configured to individually bend into the plurality of bent positions and retain a selected bent position until bent into another selected bent position.

11. The device of claim 9, wherein the body comprises a flexible polymeric material and the one or more flexible elements comprises one or more interior metal wires extending continuously through the two arms.

12. The device of claim 11, wherein the one or more interior metal wires comprises a single continuous metal wire with free ends that are arranged into a loop at a free end of each arm of the two flexible arms, and wherein the free end of each arm is spaced away from the central portion.

13. The device of claim 9, wherein a first arm of the two arms includes a first power button configured to control a first motor of the two motors, and wherein a second arm of the two arms includes a second power button configured to control a second motor of the two motors.

14. The device of claim 9, wherein the central portion includes one or more raised elements arranged between the region of each arm that the motors are arranged within, and that extend radially outward relative to each region of each arm, and relative to a central longitudinal axis of the device, wherein one or more of the one or more raised elements are configured to vibrate.

15. A device comprising:
two flexible arms extending outward from opposite sides of a central portion of the device, both arms of the two arms configured to individually bend into a plurality of bent positions and retain a selected bent position until bent into another selected bent position, wherein the two flexible arms and the central portion are formed by a body and one or more flexible elements extending continuously through the two arms and the central portion within an interior of the body; and
two individually vibrating motors configured to be individually controlled, each motor of the two individually vibrating motors arranged within a corresponding arm of the two arms, within the interior of the body, and wherein the one or more flexible elements extend around the two individually vibrating motors.

16. The device of claim 15, wherein the body comprises a flexible polymeric material, and wherein the one or more flexible elements extend between and encircle the two individually vibrating motors.

17. The device of claim 16, wherein the one or more flexible elements comprise a single, continuous wire that extends from a first end of the device to a second end of the device and that coils around each of the two individually vibrating motors one or more times and extends between the two individually vibrating motors.

18. The device of claim 15, where a first arm of the two flexible arms has a first size and a second arm of the two flexible arms has a second size, the second size larger than the first size.

19. The device of claim 15, wherein the central portion comprises one or more raised elements that extend radially outward relative to a central longitudinal axis of the device and around a circumference of the device, and wherein the one or more raised elements are disposed between the two individually vibrating motors in an axial direction.

20. The device of claim 15, wherein the two individually vibrating motors comprise a first motor and a second motor, each of the first motor and the second motor disposed within a region of a corresponding arm of the two arms that is disposed in the central portion and further comprising a third vibrating motor disposed in a distal, free end of a first arm of the two arms and a fourth vibrating motor disposed in a distal, free end of a second arm of the two arms.
